(19) United States
(12) Patent Application Publication
(10) Pub. No.: US 2016/0375865 A1
(43) Pub. Date: Dec. 29, 2016

(54) ADAPTER FOR A MOTOR VEHICLE WINDSCREEN WIPER AND ASSEMBLY HAVING SUCH AN ADAPTER

(71) Applicant: Valeo Systèmes d'Essuyage, Le Mesnil Saint Denis (FR)

(72) Inventors: Claude Aliberti, Lempdes (FR); Vincent Gaucher, Ennezat (FR); Guillaume Mouleyre, Saint Genes Champanelle (FR)

(73) Assignee: Valeo Systèmes d'Essuyage, Le Mesnil Saint Denis (FR)

(21) Appl. No.: 15/193,253

(22) Filed: Jun. 27, 2016

(30) Foreign Application Priority Data
Jun. 26, 2015 (FR) 1555909

(51) Int. Cl. B60S 1/38

(52) U.S. Cl. CPC B60S 1/3849; B60S 1/3874; B60S 1/3806; B60S 1/3887; B60S 2001/4054

(57) ABSTRACT

Adapter (826) for a windscreen wiper, in particular a motor vehicle windscreen wiper, comprising a body configured to be mounted in a yoke of substantially U-shaped cross section of a wiper arm, said body having a substantially U-shaped cross section and having two side was (826a, 826b) connected together by an upper wall (826c).

The upper wall has a fastening means configured to be housed in at least one through-orifice of said yoke, said fastening means having two separate elements (850e, 850b, 850c) that protrude from the upper we and respectively bear a contact surface (850b1, 850c1) for contact with an edge of one and the same orifice in the yoke, at least one (850c) of said two separate elements being flexible.

The adapter can be applied in an assembly having at least one wiper arm and/or a wiper blade.

### TECHNICAL FIELD

The present invention relates notably to an adapter for a windscreen wiper, in particular a motor vehicle windscreen wiper.

### PRIOR ART

A motor vehicle is conventionally equipped with windscreen wipers for washing the windscreen and avoiding disruption to the driver's view of his surroundings. These windscreen wipers generally comprise a driving arm that carries out an angular to-and-fro movement and have elongate blades which themselves carry squeegee blades made of a resilient material. These squeegee blades rub against the windscreen and evacuate the water by removing it from the driver's field of view. The blades are produced in the form either, in a conventional version, of articulated brackets which hold the squeegee blade at a number of discrete locations, giving it a bend that allows it to follow whatever curvature the windscreen may have, or, in a more recent version, known as the “flat blade” version, of a semi-rigid assembly which holds the squeegee blade along its entire length by virtue of one or more bend-forming vertebrae for pressing the blade against the windscreen without having to use brackets.

In both solutions, the blade is attached to the driving arm by a connection system having a connector and an adapter. The connector is a piece which is secured to the blade and which is generally fastened directly to the squeegee blade or to the flat blade, whereas the adapter is secured to the arm. The adapter is an intermediate piece which allows the connector to be finked and fastened to the driving arm. It is generally configured to be inserted into a head or end piece, in the form of a yoke and having a U-shaped cross section, of the driving arm.

Each of these members (connector and adapter) comprises articulation means configured to cooperate with complementary means of the other member so as to define at least one transverse articulation axis of the members, which is an articulation axis of the blade with respect to the arm. In the current art, one of these members such as the connector, generally comprises a substantially cylindrical physical in which defines the articulation axis and is received in a housing of complementary shape in the other member.

The adapter generally has a body configured to be inserted into the end piece of the arm such that this body extends at least partially between two substantially parallel side was of the end piece.

An adapter makes it possible to join a blade to a particular type of end piece. In the case of the abovementioned end pieces with a U-shaped cross section, several varieties thereof exist.

A wiper arm of which the end piece bears a cover that slides in longitudinal translation is known. The cover is mounted so as to slide between a first, forward position and a second, retracted position. In addition to its attractive appearance, this type of cover can have further functions.

The invention proposes an improved adapter that is particularly, but not exclusively, suited to this technology of an end piece with a sliding cover, and is simple, effective and economical.

### SUMMARY OF THE INVENTION

According to a first aspect, the invention proposes an adapter for a windscreen wiper, in particular a motor vehicle windscreen wiper, comprising a body configured to be mounted in a yoke of substantially U-shaped cross section of a wiper arm, said body having a substantially shaped cross section and having two side was that are delimited longitudinally by a front longitudinal end edge and a rear longitudinal end edge and are connected together by an upper wall, said upper wall having a first protruding element configured to extend at least partially into a through-orifice of said yoke, characterized in that said first element comprises at least one lower surface, which is oriented towards said upper wall and which is configured to cooperate with the yoke, or with a cover mounted in a sliding manner on the yoke, by bearing and/or sliding, so as to retain the adapter with respect to the arm.

The adapter according to the invention can comprise one or more of the following features, taken individually or in combination with one another:
said first protruding element is in the overall shape of an L or U,
said first protruding element is arranged in the vicinity of the rear longitudinal end edge,
said first protruding element comprises a tab having said lower surface,
said tab is substantially parallel to said upper wall,
said body has an elongate overall shape, the axis of elongation of which is substantially parallel to the side was and upper wall,
said tab has a longitudinal overall orientation,
the first protruding element comprises a lower portion which directly extends the upper wall and which hears said tab,
the first protruding element has a shape and dimensions that are configured such that said first protruding element cooperates with the through-orifice of said yoke,
the first protruding element comprises an upper surface which is oriented away from the upper wall and which is configured to cooperate by sliding with a part of the sliding cover of the arm,
the tab is configured to cooperate with the yoke by bearing and/or sliding,
the tab directly extends the lower portion on the opposite side from the upper wall,
the tab is offset longitudinally with respect to said lower portion,
the tab extends longitudinally beyond the rear longitudinal end edge,
the tab is configured to cooperate with the sliding cover of the arm by bearing and/or sliding,
the first protruding element comprises an intermediate portion which extends the lower portion in order to bear an upper portion forming the tab,
the tower portion comprises an upper surface which faces said lower surface so as to form a region for receiving the cover,
said upper and lower surfaces are substantially parallel,
the body comprises, on an external side face of each of its side walls, at least one, and preferably only one, second protruding element configured to be inserted into a through-notch of said yoke,
the first protruding dement is arranged in the vicinity of the rear longitudinal end edge, whereas said second protruding element is arranged in the vicinity of the front longitudinal end edge.

The present invention also relates to an assembly having a wiper arm and an adapter as described above.

Preferably, said arm has an elongate overall shape and has a yoke with a substantially U-shaped cross section and having two longitudinal side was connected together by an upper longitudinal wall which has an orifice for accommodating said protruding element of the adapter, said arm also having a cover mounted so as to slide in longitudinal translation on the yoke. When the adapter has second protruding elements, notches can be made in the longitudinal side was of the yoke in order to receive these second protruding elements.

In such an assembly, provision may be made for:
the cover to be configured to be movable between a forward position, in which it is spaced apart from said orifice, and a retracted position, in which it at least partially covers said first protruding element,
the cover to comprise, in the upper wall, a notch for receiving at least a part of said first protruding element. This notch can come into abutment against an intermediate portion of the first protruding element, or against the tab.

The present invention also relates to an assembly having a wiper blade and an adapter as described above, said adapter preferably being mounted on said blade via a connector.

According to a second aspect, the invention relates to an adapter for a windscreen wiper, in particular a motor vehicle windscreen wiper, comprising a body of elongate shape configured to be mounted in a yoke of substantially U-shaped cross section of a wiper arm, said body having a substantially U-shaped cross section and having two longitudinal side walls connected together by an upper longitudinal wall characterized in that said body comprises, at at least one of its longitudinal ends, at least one tab which extends in the longitudinal direction and which is configured to cooperate with the arm or a member borne by the arm so as to retain the adapter with respect to the arm or this member.

The adapter according to the invention can comprise one or more of the following features, taken individually or in combination with one another:
said at least one tab extends longitudinally from the upper wall and/or from one or both side walls,
each of said side walls comprises a longitudinal tab,
each longitudinal tab has a planar shape,
said side walls and upper wall are partially extended longitudinally to form a common tab, having a substantially U-shaped cross section,
said body has a plane of symmetry parallel to the side walls and passing substantially through the middle of the upper wall,
said body comprises, on an external side face of each of its side walls, at least one, and preferably only one, second protruding element configured to be inserted into a through-notch of said yoke,
the at least one tab and the second protruding element are disposed longitudinally on either side of an articulation axis of the adapter that passes through corresponding means, and
said body is formed in one piece.

The present invention also relates to an assembly having a wiper arm and an adapter as described above.

Preferably, said arm has an elongate overall shape and has a yoke with a substantially U-shaped cross section and having two longitudinal side walls connected together by an upper longitudinal wall, said arm also having a cover mounted so as to slide in longitudinal translation on the yoke.

Advantageously, said at least one tab is configured to cooperate with the cover, and in particular with at least one guide rail for guiding the sliding of the cover, by bearing.

The cover can be configured to be movable in longitudinal translation between a first position and a second position in which said at least one guide rail retains the adapter by cooperating with said at least one tab.

An end fitting can be mounted at a free longitudinal end of the yoke and closes, at this end, a space that extends between the side walls and upper wall of the yoke.

Preferably, said at least one tab is configured to cooperate with said and fitting by bearing.

Advantageously, said at least one tab is inserted into a recess made in that face of said end fitting that faces the interior of the yoke.

The present invention also relates to an assembly having a wiper blade and an adapter as described above said adapter preferably being mounted on said blade via a connector.

According to a third aspect, the invention relates to an adapter for a windscreen wiper, in particular a motor vehicle windscreen wiper, comprising a body configured to be mounted in a yoke of substantially U-shaped cross section of a wiper arm, said body having a substantially U-shaped cross section and having two longitudinal side walls connected together by an upper longitudinal wall; characterized in that it comprises a fastening device which is configured to form a closed loop around said yoke or around a member mounted on the yoke. The fastening device is notably configured to take up an open position and a closed position in which it forms said closed loop.

The adapter according to the invention can comprise one or more of the following features, taken individually or in combination with one another:
said device is flexible, deformable and/or able to be articulated,
said device comprises a first retaining element and a second retaining element, the first retaining dement having an end connected to said body and en opposite end having a fastening means configured to cooperate with a complementary fastening means at one end of the second retaining element, the opposite end of which is connected to said body,
said fastening means is a hook, a lip or a tab,
said body has an elongate overall shape and is connected to a fastening device at one longitudinal end, or each of its longitudinal ends,
the device comprises two parallel fastening straps spaced apart from one another,
said fastening device comprises a folding cover configured to cover said yoke at least in part,
said folding cover is articulated about a longitudinal axis,
said folding cover has the overall shape of a U and comprises two side was connected together by an upper wall, the upper wall of the folding cover being configured to cover the yoke or the member mounted on the yoke, and its side was being configured to extend along two opposite sides of the yoke,
one of the side was of the folding cover comprises, at one longitudinal edge, at least one fastening means of the cover, and the other of its side was comprises, at one longitudinal edge, at least one articulation hinge of the cover,
said body is formed in one piece.

The present invention also relates to an assembly having a wiper arm and an adapter as described above.

Advantageously, said arm has an elongate overall shape and has a yoke with a substantially U-shaped cross section and having two longitudinal side walls connected together by an upper longitudinal wall, said arm also having a cover mounted so as to slide in longitudinal translation on the yoke, said fastening device being configured to form a closed loop about at least the sliding cover.

The present invention also relates to an assembly having a wiper blade and an adapter as described above, said adapter preferably being mounted on said blade via a connector.

According to a fourth aspect, the invention relates to an adapter for a windscreen wiper, in particular a motor vehicle windscreen wiper, comprising a body of elongate shape configured to be secured to a yoke of substantially U-shaped cross section of a wiper arm, said body having a substantiality U-shaped cross section and having two longitudinal side walls connected together by an upper longitudinal wall, characterized in that it comprises, at one longitudinal end of the body, a cowling secured to the body, said cowling being able to define a housing for receiving an end part of the yoke, said side walls of the body having articulation means configured to receive first complementary means of a windscreen wiper connector and notably joined to first elastically deformable elastic snap-fastening means that are configured to cooperate with said complementary means while they are being received by said articulation means. The side walls of the body also have second elastically deformable elastic snap-fastening means that are configured to cooperate with second complementary means of said yoke.

The adapter according to the invention can comprise one or more of the following features, taken individually or in combination with one another:
said side walls of the body respectively comprise two orifices which are aligned and form said articulation means,
said side was of the body respectively comprise two longitudinal slots which extend from said orifices on the opposite side from said cover,
each of said side walls of the body comprises a lower longitudinal tab, an upper part of which defines a peripheral part of the corresponding orifice,
said lower tab being at least partially elastically deformable and forming said first elastic snap-fastening means,
said lower tab has a free longitudinal end having a sliding ramp configured to cooperate with a journal of the connector,
each of said side was of the body comprises en upper tab, a lower part of which defines a peripheral part of the corresponding orifice, said upper tab being at least partially elastically deformable and forming said second elastic snap-fastening means,
said upper tab is in the overall shape of an L and comprises two substantially rectilinear portions, a first portion of which extends from the corresponding orifice on the opposite side from said cover and is connected, on the opposite side from the cover, to a second portion which extends downwards,
the second portions of the upper tabs respectively comprise two transverse fingers that extend in opposite directions and are configured to be inserted by elastic snap-fastening into notches of said yoke,
said fingers extend in one and the same longitudinal plane that passes substantially through said lower tabs,
the cowling has a cross section substantially in the shape of a U, said cowling having two side was that are connected together by en upper wall and extend respectively parallel to and at a distance from the side was and from the upper wall of the body so as to define said receiving housing between the was of the cowling and the was of the body,
the cowling has a front end wall extending transversely to the two side wells, said front end wall forming an abutment wall for the end part of the yoke, and
the adapter is formed in one piece.

The present invention also relates to an assembly having a wiper arm and an adapter as described above.

Advantageously, said arm has an elongate overall shape and has a yoke With a substantially U-shaped cross section and having two longitudinal side was connected together by an upper longitudinal wall.

Preferably, said yoke comprises notches on its longitudinal side walls, which open out respectively onto free longitudinal lower edges of these walls, said second elastic snap-fastening means of the adapter cooperating with at least some of said notches.

Said second elastic snap-fastening means of the adapter may cooperate with the notches of the yoke that are furthest away from a free longitudinal end of the yoke.

The present invention also relates to an assembly having a wiper blade and an adapter as described above, said adapter preferably being mounted on said blade via a connector.

According to a fifth aspect, the invention relates to an adapter for a windscreen wiper, in particular a motor vehicle windscreen wiper, comprising a body of elongate shape configured to be mounted in a yoke of substantially U-shaped cross section of a wiper arm, said body having a substantially U-shaped cross section and having two longitudinal side was connected together by an upper longitudinal wall, characterized in that said upper wall has a fastening means configured to be housed in at least one through-orifice of said yoke, said fastening means having two separate elements that protrude from the upper wall and respectively bear a contact surface for contact with an edge of one and the same orifice in the yoke, at least one of said two separate elements being flexible.

The adapter according to the invention can comprise one or more of the following features, taken individually or in combination with one another:
the two protruding elements of said fastening means have a first flexible protruding element, articulated about an axis formed by the junction line between the upper wall and said first protruding element, and a second protruding element in the form of a fixed protuberance,
the second protruding element is in the overall shape of a parallelepiped,
the two protruding elements of said fastening means have two flexible protruding elements, respectively articulated about an axis formed by the junction line between the upper wall and said corresponding protruding element,
the contact surfaces borne respectively by the protruding elements are oriented away from one another,
the flexible protruding element(s) are in the overall shape of an L and comprise a substantially rectilinear portion that extends upwards from said upper wall and is connected at its upper end to a lip oriented towards a longitudinal end of the body,
the lip is configured to cooperate with said yoke by bearing so as to retain the adapter with respect to the yoke,
the upper wall bears a third protruding element,
the third protruding element is in the overall shape of a cylinder,
the third protruding element is configured to be inserted into another orifice in said yoke,
the three protruding elements of the upper waif are aligned, and
said body is formed in one piece.

The present invention also relates to an assembly having a wiper arm and an adapter as described above.

Advantageously, said arm has an elongate overall shape and has a yoke with a substantially U-shaped cross section and having two longitudinal side walls connected together by an upper longitudinal wall, said arm also having a cover mounted so as to slide in longitudinal translation on the yoke.

The present invention also relates to an assembly having a wiper blade and an adapter as described above, said adapter preferably being mounted on said blade via a connector.

According to a sixth aspect, the invention relates to an adapter for a windscreen wiper, in particular a motor vehicle windscreen wiper, comprising a body of elongate shape configured to be mounted in a yoke of substantially U-shaped cross section of a wiper arm, said body having a substantially U-shaped cross section and having two longitudinal side was connected together by an upper longitudinal wall, characterized in that the adapter is configured to be inserted into said yoke by translational movement in a direction substantially perpendicular to said upper wall, and in that said side was comprise tabs that are elastically deformable in the transverse direction and are configured to cooperate by elastic snap-fastening with complementary means of the yoke and/or of a member mounted on the yoke, said tabs having retaining teeth configured to cooperate with the yoke and/or said member.

The adapter according to the invention can comprise one or more of the following features, taken individually or in combination with one another:
each of said side walls has two elastically deformable tabs,
each of said tabs has a overall orientation perpendicular to said upper wall,
each of said tabs is delimited by two parallel through-slots that are formed in the corresponding side wall and open onto a free lower edge of this side wall,
each of said tabs has at least one retaining tooth configured to cooperate with the yoke and/or said element,
each of said tabs comprises an upper tooth and a lower tooth,
the teeth of each tab are spaced apart from one another and define between one another a space for receiving a part of the yoke and/or of said member,
the upper tooth of each tab has a sliding ramp,
the upper tooth has a lower bearing surface and/or abutment surface,
the lower tooth has an upper bearing surface and/or abutment surface, and
said body is formed in one piece.

The invention also relates to an assembly having a wiper arm and an adapter as described above.

Advantageously, said arm has an elongate overall shape and has a yoke with a substantially U-shaped cross section and having two longitudinal side was connected together by an upper longitudinal wall, said arm also having a cover mounted so as to slide in longitudinal translation on the yoke.

The cover is advantageously mounted so as to slide in a direction perpendicular to the direction of insertion of the adapter into the yoke.

Preferably, said tabs are configured to cooperate by elastic snap. fastening with the cover, and in particular with the guide rails for guiding the sliding of the cover.

The cover can be configured to be movable in longitudinal translation between a first position and a second position in which said guide rain retain the adapter by cooperating with said tabs.

The present invention also relates to an assembly having a wiper blade and an adapter as described above, said adapter preferably being mounted on said blade via a connector.

The invention also relates to a method for mounting an adapter in a yoke of such an assembly, during which method the sliding cover is moved in a longitudinal direction into a retracted position close to the yoke, in which the guide rails borne by the cover are disposed along the passage of insertion of the adapter into the yoke, during which the adapter is inserted into the yoke by translational movement in a direction substantially perpendicular to the longitudinal sliding direction of the cover, while the sliding cover is in said retracted position, and during which the translational movement of the adapter is continued by elastically deforming the tabs of the adapter in contact with the guide rails until said guide rails and said tabs that have returned into the initial position are elastically snap-fastened.

According to a seventh aspect, the invention relates to an adapter for a windscreen wiper, in particular a motor vehicle windscreen wiper comprising a body configured to be mounted in a yoke of substantially U-shaped cross section of a wiper arm, said body having a substantially U-shaped cross section and having two side walls connected together by an upper wall, said upper wall having a first protruding element configured to extend at least partially into a through-orifice of said yoke, characterized in that at least one of its was comprises an elastically deformable tongue configured to bear against an internal face of said yoke in order to remove any clearance between the adapter and this internal face.

The adapter according to the invention can comprise one or more of the following features, taken individually or in combination with one another:
said at least one tongue is situated on the upper wall of the body, one tongue is situated on the upper wall of the body and one tongue is situated on at least one side wall,
said tongue is situated in the vicinity of one longitudinal end of the body and said protruding element is situated at an opposite longitudinal end of the body,
said tongue is configured to be deformable between a non-loaded position in which it protrudes from the corresponding wall of the body, and a folded position in which it is in the plane of the body,
said tongue is situated in a recess or orifice in the body,
said first protruding element comprises at least one lower surface, which is oriented towards said upper wall, and which is configured to cooperate with the yoke or with a cover mounted in a sliding manner on the yoke, by bearing and/or sliding, so as to retain the adapter with respect to the yoke,
said first protruding element is in the overall shape of an L or U,
said body has a plane of symmetry parallel to the side was and passing substantially through the middle of the upper wall,
said piano of symmetry passes substantially in its middle through said tongue, and
said body comprises, on an external side face of each of its side walls, at least one, and preferably only one, second protruding element configured to be inserted into a through-notch of said yoke.

The invention also relates to an assembly having a wiper arm and an adapter as described above.

Advantageously, said arm has an elongate overall shape and has a yoke with a substantially U-shaped cross section and having two longitudinal side walls connected together by an upper longitudinal wall which has an orifice for accommodating said first protruding element of the adapter, said arm also having a cover mounted so as to slide in longitudinal translation on the yoke.

Preferably, the cover is configured to be movable between a first position, in which it is spaced apart from said orifice, and a second position, in which it is near to said orifice, or partially covers said orifice and/or a part of said element.

The cover may comprise a notch for receiving at least a part of said element.

The present invention also relates to an assembly having a wiper blade and an adapter as described above, said adapter preferably being mounted on said blade via a connector.

According to an eighth aspect, the invention relates to an adapter for a windscreen wiper, in particular a motor vehicle windscreen wiper, comprising a body configured to be mounted in a yoke of substantially U-shaped cross section of a wiper arm, said body having a substantially U-shaped cross section and having two side walls connected together by an upper wall, said upper wall having a protruding element configured to extend at least partially into a through-orifice of said yoke, characterized in that it also comprises at least one clip configured to be attached and fastened to said element in order to lock the adapter with respect to said yoke.

The adapter according to the invention can comprise one or more of the following features, taken individually or in combination with one another:
said element is in the overall shape of a T and comprises a first wall substantially parallel to the upper wall and a second wall for connecting the first wall to the upper wall, said second wall being substantially perpendicular to the upper wall,
said first wall extends substantially in a longitudinal median plane of symmetry of the body,
the clip is in the overall shape of a U and comprises two substantially parallel fingers connected by one of their ends to a common base,
the fingers are elastically deformable by being moved towards and/or away from one another,
the fingers comprise retaining hooks at their ends away from the common base, and
said body comprises, on an external side face of each of its side walls, at least one, and preferably only one, protuberance configured to be inserted into a through-notch of said yoke.

The invention also relates to an assembly having a wiper arm and an adapter as described above.

Advantageously, said arm has an elongate overall shape and has a yoke with a substantially U-shaped cross section and having two longitudinal side walls connected together by an upper longitudinal wall which has an orifice for accommodating said protruding element of the adapter, said arm also having a cover mounted so as to slide in longitudinal translation on the yoke.

Preferably, the cover is configured to be movable between a first position, in which it is spaced apart from said orifice, and a second position, in which it is near to said orifice, or partially covers said orifice and/or a part of said element.

The cover may comprise a notch for receiving at least a part of said element and/or a part of said clip.

The present invention also relates to an assembly having a wiper blade and an adapter as described above, said adapter preferably being mounted on said blade via a connector.

The invention also relates to a method for mounting an assembly as described above, which comprises the steps of:
a) mounting the adapter in the yoke of the arm such that said element passes through the orifice in the yoke,
b) mounting the clip in contact with the yoke and around said first protruding element, and
c) moving the cover on the yoke.

In step b), the dip is preferably mounted on the yoke and the member by sliding it on an upper wall of the yoke.

Step c) can consist in moving the cover on the yoke until at least a part of the dip is housed in the notch in the cover, so as to lock the clip with respect to the member.

According to a ninth aspect, the invention relates to an adapter for a windscreen wiper, in particular a motor vehicle windscreen wiper, characterized in that it has an elongate shape and is configured to be secured to a cover of a wiper arm, said adapter having a front cowling and a rear body which is substantially U-shaped in cross section and has two side was connected together by an upper wall, said front cowling having a front wall which is configured to extend in front of said rear body so as to define with said body a longitudinal space for receiving at least a part of said cover.

The adapter according to the invention can comprise one or more of the following features, taken individually or in combination with one another:
said cowling is in the overall shape of a U, the middle part of which is formed by said front wall, and the side parts are formed by side walls which extend rearwards from said front part,
said cowling comprises an upper opening for mounting said cover in said space,
said side was of the body respectively comprise two aligned orifices,
said side was of the body have elastically deformable elastic snap-fastening means that are configured to cooperate width complementary means of said cover,
each of said side walls of the body comprises an elastically deformable longitudinal tab forming said elastic snap-fastening means,
said tab is in the overall shape of an L and comprises two substantially rectilinear portions, a first portion of which extends rearwards in continuation of the rear body and is connected to a second portion which extends downwards,
said tab has a notch for receiving a complementary means of said cover,
said receiving notch is made in the lower face of the first portion,
the second portions of the upper tabs respectively comprise two transverse fingers that extend in opposite directions and are configured to form actuating means,
said fingers extend in one and the same longitudinal plane, and
the adapter is formed in one piece.

The present invention also relates to an assembly having a wiper arm and an adapter as described above.

Advantageously, said arm has an elongate overall shape and has a yoke with a substantially U-shaped cross section and having two longitudinal side walls connected together by an upper longitudinal and a cover mounted so as to slide in longitudinal translation on said yoke.

The present invention also relates to an assembly having a wiper blade and an adapter as described above, said adapter preferably being mounted on said blade via a connector.

### DESCRIPTION OF FIGURES

The invention will be better understood and further details, features and advantages of the invention viii become apparent from reading the following description given by way of non-limiting example and with reference to the appended drawings, in which:

FIG. 1 is a schematic perspective view of a windscreen wiper, this windscreen wiper having a wiper blade, an arm for driving the blade, and a system for connecting the blade to the arm,

FIG. 2 is a schematic perspective view on a larger scale of a part of a wiper arm equipped notably with a sliding cover,

FIG. 3 is an exploded schematic perspective view of the wiper arm from FIG. 2,

FIGS. 4a and 4b are schematic perspective views of an adapter according to a first aspect of the invention,

FIG. 5 is a partially cutaway schematic perspective view of a wiper arm equipped with the adapter from FIGS. 4a and 4b, the sliding cover not being shown here,

FIGS. 6a, 6b and 7 are schematic perspective views of the assembly formed by the arm equipped with the cover and with the adapter from FIGS. 4a and 4b, the cover being shown in a partially cutaway manner in FIG. 7,

FIGS. 8a and 8b are schematic perspective views of an adapter according to a variant embodiment of the first aspect of the invention,

FIG. 9 is a schematic perspective view of a wiper arm equipped with the adapter from FIGS. 8a and 8b, the sliding cover not being shown,

FIGS. 10a, 10b and 11 are schematic perspective views of the assembly formed by the arm equipped with the cover and with the adapter from FIGS. 8a and Bb, the cover being shown in a partially cutaway manner in FIG. 11,

FIG. 12 is a schematic perspective view of an adapter according to a second aspect of the invention,

FIGS. 13a and 13b are schematic perspective bottom views of the assembly formed by the arm and the adapter from FIG. 12, the sliding cover not being shown,

FIG. 14 is a schematic perspective view of an adapter according to a variant embodiment of the second aspect of the invention,

FIGS. 15a and 15b are schematic perspective bottom views of the assembly formed by the arm and the adapter from FIG. 14, the sliding cover being shown in FIG. 15b,

FIG. 16 is a schematic perspective view of an adapter according to a third aspect of the invention,

FIGS. 17a and 17b are schematic perspective views of the assembly formed by the arm and the adapter from FIG. 16,

FIGS. 18a to 18c are schematic perspective views of the assembly formed by the arm and an adapter according to a variant embodiment of the third aspect of the invention,

FIGS. 19a and 19b are schematic perspective views of an adapter according to a fourth aspect of the invention,

FIGS. 20a to 20c and 21 are schematic perspective views of the assembly formed by at least the arm and the adapter from FIGS. 19a and 19b, FIGS. 20a to 20c illustrating the steps of fitting the adapter on the arm, and FIG. 21 illustrating the assembly formed by the arm (partially cutaway) and the adapter, opposite a connector,

FIG. 22 is a schematic perspective view of an adapter according to a fifth aspect of the invention,

FIG. 23 is a schematic perspective view of the assembly formed by the arm and the adapter from FIG. 22,

FIGS. 24a and 24b are schematic perspective cross-sectional views of an adapter according to a sixth aspect of the invention,

FIGS. 25 and 26 are schematic views of the assembly formed by the arm and the adapter from FIGS. 24a and 24b, FIG. 25 being an exploded perspective depiction and FIG. 26 being a cross-sectional view of the assembled assembly,

FIG. 27 is a schematic perspective view of an adapter according to a seventh aspect of the invention,

FIG. 28 is schematic view in axial section of the assembly formed by the arm and the adapter from FIG. 27,

FIGS. 29a and 29b and 30 are schematic perspective views of the assembly formed by the arm and an adapter according to an eighth aspect of the invention, FIG. 29b being an exploded view of each of the components of this assembly,

FIG. 31 is a schematic perspective view of the assembly formed by the arm and an adapter according to a ninth aspect of the invention,

FIG. 32 is a schematic perspective view of the adapter from FIG. 31,

FIGS. 33a to 33d are schematic perspective views of steps for mounting the assembly formed by the arm and the adapter from FIG. 31, and

FIGS. 34 and 35 are schematic perspective bottom views of the assembly, a connector being illustrated in FIG. 34.

### DETAILED DESCRIPTION

It should be noted that the figures explain the invention in detail for implementing the invention, it being of course possible for said figures to serve to better define the invention if necessary.

In the following description, the denominations longitudinal or lateral refer to the orientation of the wiper blade or of the driving arm according to the invention. The longitudinal direction corresponds to the main axis of the blade or arm along which it extends, while the lateral orientations correspond to concurrent straight lines, that is to say straight lines which cross the longitudinal direction, notably perpendicular to the longitudinal axis of the blade or arm in the plane in which it rotates. For longitudinal directions, the denominations rear or front are to be assessed with respect to the point at which the blade is fastened to the arm, the denomination rear corresponding to the part where the arm and a half-blade extend, or with respect to the point at which the arm is fastened to the vehicle. Finally, the directions referenced as upper or lower correspond to orientations perpendicular to the plane of rotation of the wiper blade, the denomination lower containing the plane of the windscreen. The directions internal, external, inner or outer can refer to a component in its entirety and relate for example to the inside or outside of this component.

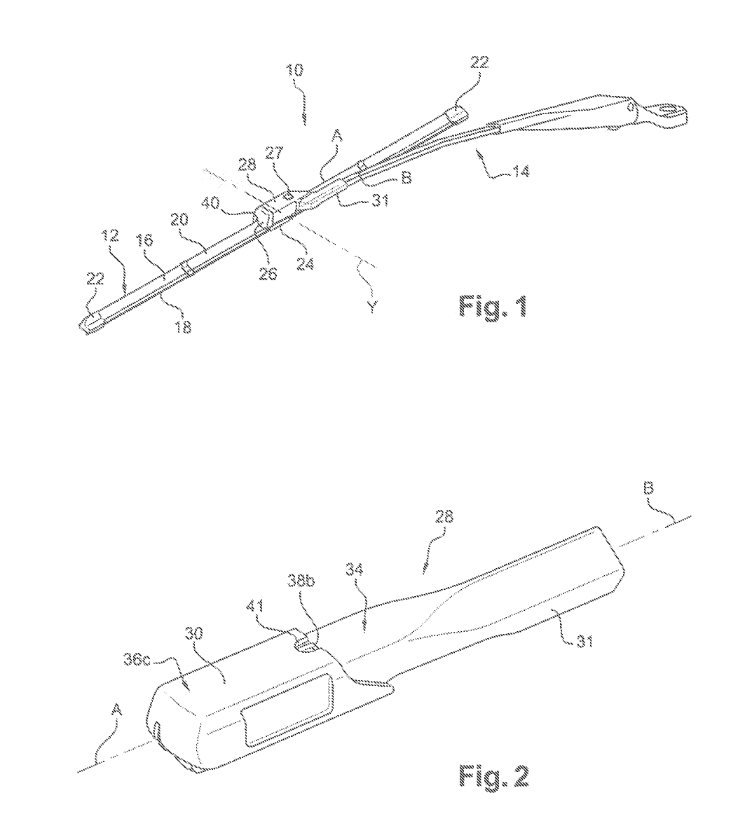

FIG. 1 illustrates a windscreen wiper 10 having notably a blade 12 and a driving arm 14 for driving the blade 12.

The blade 12 is preferably of the flat blade type and comprises a longitudinal body 16, a squeegee blade 16, generally made of rubber, and at least one vertebra (not visible) which stiffens the squeegee blade and encourages it to press against a vehicle windscreen.

The body 16 of the blade 12 may comprise an upper aerodynamic deflector 20 intended to improve the operation of the wiping system, the purpose of this deflector being to improve the pressing of the blade against the windscreen and therefore the aerodynamic performance of the windscreen wiper.

The blade 12 may further comprise end fittings 22 or clips for attaching the squeegee blade 18 and the vertebra to the body 16, these end fittings 22 being situated at each of the longitudinal ends of the body 16.

The blade 12 comprises, substantially at its middle, an intermediate connector 24. An adapter 26 secured to the arm 14 is mounted on the connector 24 so as to maintain a degree of freedom to pivot about an articulation axis Y which is a transverse axis substantially perpendicular to the longitudinal axis of the blade 12. This degree of freedom allows the blade 12 to pivot with respect to the arm 14 and thus allows the blade to follow the curvature of the windscreen as it moves. The adapter 26 can be detached from the arm 14 by pressing an actuation button, in this case a pushbutton 27, borne by the adapter. The arm 14 is intended to be driven by a motor to follow a back and forth angular movement that allows water and possibly other undesirable elements with which the windscreen is covered to be evacuated. The adapter 26 provides the connection of the blade 12 to the arm 14 and, in particular, to a head or end piece of the arm which may be formed as one piece with the arm or attached and fastened thereto.

In the case of FIG. 2, the end piece of the arm comprises or forms a yoke 28 with a substantially U-shaped cross section, on which a cover 30 is mounted so as to slide.

The yoke 28 has an elongate shape, the axis of elongation A of which is generally substantially parallel to the axis of elongation or longitudinal axis of the blade 12. The yoke 28 comprises a part 31 for connecting to the rest of the arm 14, for example by crimping. This part 31 has an elongate overall shape and extends along an axis B substantially parallel to the axis A and spaced apart from this axis, as can be seen in FIGS. 1 and 2. The part 31 is connected to a rear end or inside end of the rest of the yoke 28.

The yoke 28 comprises two side walls 32a, 32b, the upper longitudinal edges of which are connected together by an upper transverse wall 34. The was 32a, 32b and 34 delimit a space for accommodating the adapter 26 between one another.

The was 32a, 32b comprise through-notches 33a, 33b, 33c, 33d which open out at the lower longitudinal edges thereof, The notches 33a, 33b, 33c, 33d in each wall 32a, 32b are disposed longitudinally one after another and there are four of them here. They are spaced apart longitudinally from one another. The front notch 33a in each wall, situated furthest forward, has a relatively small width compared with the other notches, and extends substantially over the entire, height of the corresponding wall 32a, 32b. The rear notch 33d, situated furthest back, has a relatively small height compared with the other notches. Finally, the intermediate notches 33b, 33c have a relatively large width compared with the front notch 33a and extend substantially to half-way up the corresponding wall 32a, 32b.

The upper wall 34 comprises two through-openings 38a, 38b disposed longitudinally one after the other. The front opening 38a has a substantially circular contour and the rear opening 38b has a substantially rectangular contour.

The cover 30 covers the yoke 28 of the end piece and has a substantially U-shaped cross section, It has an elongate shape and comprises two longitudinal side walls 36a, 36b, the upper longitudinal edges of which are connected together by an upper longitudinal wall 36c. The front edges of the was 36a, 36b, 36c are furthermore connected together by a front wall 36d of the cover. As can be seen in FIG. 2, the upper wall 36c of the cover covers the upper wall 34 of the yoke and its side walls 36a, 36b extend on either side of the yoke, next to the side walls 32a, 32b. The front wall 36d of the cover extends in front of the yoke and comprises a slot 40 for receiving an upper part of the deflector 20 of the blade 12, visible in FIG. 1. Finally, the upper wall 36c of the cover 30 comprises, at its rear end, a notch 41 in the overall shape of a U, which opens onto the free rear edge of the wall 36c and which is oriented towards the rear or the outside of the arm.

The cover 30 is able to move in longitudinal translation on the yoke of the arm, from a retracted position shown in FIG. 2, to a forward position. In the forward position, the notch 41 in the cover 30 can be situated at the opening 38a in the yoke and, in the retracted position, this notch 41 can be situated at the opening 38b. To this end, the cover comprises means for guiding in translational movement that are intended to cooperate with the yoke. In the example shown, each side wall 36a, 36b of the cover comprises a guide rail 42 at its lower longitudinal edge. Each rail 42 is in the form of a series of substantially coplanar longitudinal lips 42a, 42b, 42c.

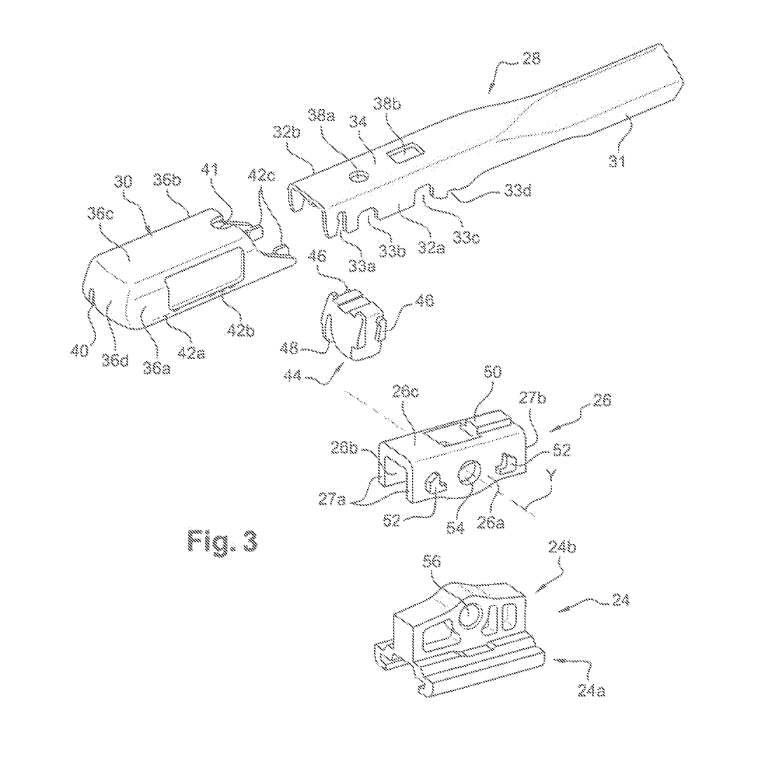

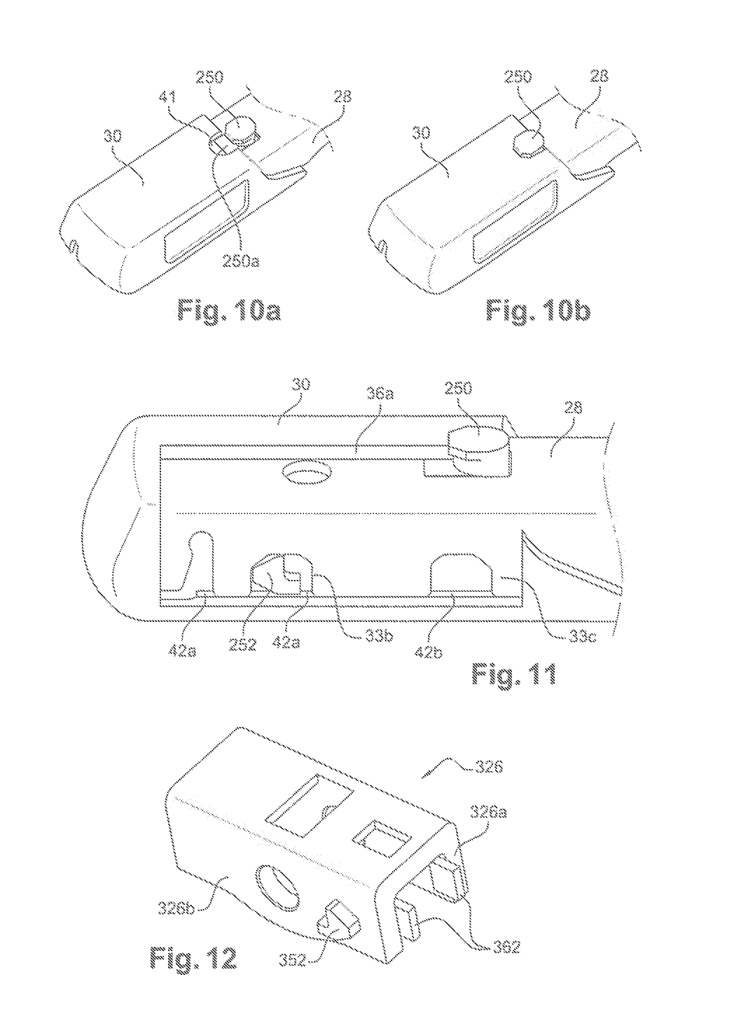

The longitudinal lips 42a, 42b, 42c of each wall 36a, 36b are disposed longitudinally one after another and there are three of them here, They are spaced apart longitudinally from one another. The front lip 42a of each wall, situated furthest forward, is shown by way of a dashed line in FIG. 3 and is best visible in FIG. 15b. The rear lip 42c, situated furthest back, has a smaller length than the lip 42a and is in the overall shape of an L. This lip 42c forms a hook, a first portion 42ca of which, substantially parallel to the upper wall 36c, connects the corresponding side wall 36a, 36b to a second portion 42cb extending parallel to this side wall 36a, 36b and at a distance therefrom. Finally, the intermediate lip 42b has a length similar to that of the lip 42a and is shown by way of a dashed line in FIG. 3 and is best visible in FIG. 10b.

During the longitudinal sliding of the cover 30 on the yoke of the arm, the lips 42a, 42b, 42c of the cover can cooperate with the free lower edges of the side walls 32a, 32b of the yoke by sliding, and the portions 42cb of the lips 42c can cooperate with the internal faces opposite these side walls 32a, 32b by sliding.

As can be seen in FIG. 3, an end fitting 44 is mounted at the free end of the yoke 28 of the arm, in order to dose the abovementioned space in the yoke, in which the adapter 26 is mounted. This end fitting 44 is in the form of a block of material, preferably elastic, which comprises lateral ribs 46 that are intended to be inserted into the front notches 33a in the side walls 32a, 32b of the yoke, in order to retain the end fitting with respect to the yoke. The end fitting 44 also comprises a dot 48 for receiving an upper part of the deflector 20 of the bade 12, visible in FIG. 1. The end fitting 44 is produced by injection-moulding, for example.

The adapter 26, visible in FIG. 3, comprises a body that is configured to be mounted in the yoke and substantially U-shaped cross section. It has two side walls 26a, 26b which are delimited longitudinally by a front longitudinal and edge 27e and a rear longitudinal end edge 27b and are connected together by an upper wall 26c. The upper wall 26c comprises a first element 50 protruding from the upper wall, in the form of a protuberance, configured to be accommodated in the opening 38b in the upper wall 34 of the yoke.

The side walls 26a, 26b each comprise two second elements 52 protruding from the associated side wait, in the form of protuberances, configured to be inserted into the intermediate notches 33b, 33c in the corresponding side wall 32a, 32b of the yoke. These second protruding elements 52 can cooperate with the sliding cover 30 in order to retain the adapter in the yoke. In its forward position, the lips 42a, 42b of the cover 30 are offset longitudinally from the intermediate notches 33b, 33c and are located for example respectively in front of the notch 33b and between the notches 33b, 33c. In this position, the notches 33b, 33c are free and the adapter 26 can be accommodated in the yoke by translational movement in a direction substantially perpendicular to the upper wall 34 of the yoke (from the bottom upwards), until the second protruding elements 52 are inserted into the intermediate notches 33b, 33c. The removal of the adapter is also enabled.

In its retracted position, the lips 42a, 42b of the cover 30 are located respectively under the intermediate notches 33b, 33c. In this position, the notches 33b, 33c are closed and the adapter 26 can be prevented from exiting the yoke by its second protruding elements 52 bearing or butting against the lips 42a, 42b of the cover.

The side walls 26a, 26b respectively comprise two aligned through orifices 54. These orifices are situated substantially in the middle of the walls 26a, 26b, between the second protruding elements 52. The orifices 54 define the substantially transverse articulation axis Y of the connector 24 with respect to the adapter 26 and thus of the blade 12 with respect to the arm 14.

The connector 24 comprises essentially two parts, a lower part 24a for crimping or fastening to the rest of the blade 12, and an upper part 24b intended to be accommodated between the side was 26a, 26b of the adapter. This upper part 24b comprises a through-orifice 56 intended to be aligned with the axis Y. The orifices 54, 56 are intended to receive a cylindrical rod defining the articulation axis Y. Alternatively, either one of the adapter 26 and the connector 24 could comprise cylindrical journals that are centred on the axis Y and are intended to be inserted by elastic snap fastening into the orifice or orifices in the other one of these members.

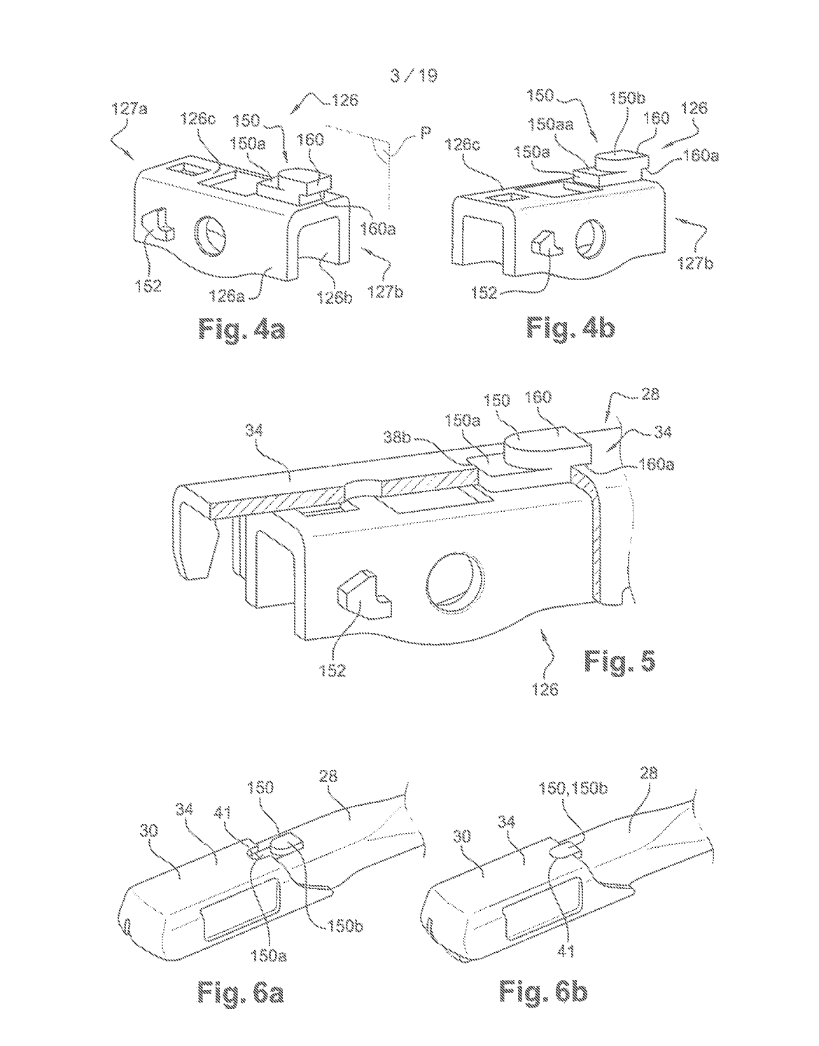

FIGS. 4a to 11 illustrate a first aspect of the invention, FIGS. 4a to 7 showing a first embodiment of this aspect and FIGS. 6 to 11 showing a variant embodiment.

According to this first aspect of the invention, the first abovementioned protruding element 150, 250 protruding from the upper we 126c, 226c of the adapter 126, 226 comprises at least one lower surface 160a, 260a which is oriented towards the upper wall 126c, 226c end which is configured to cooperate with the yoke 28 or with the cover 30 by bearing end/or siding, in order to retain the adapter with respect to the arm.

In the case of FIGS. 4a to 7, the first protruding element 150 comprises a lower surface 160e which is oriented towards said upper wall 126c and which is configured to cooperate with the yoke by bearing end/or sliding in order to retain the adapter with respect to the yoke.

In the example shown, the first protruding element 150 is in the overall shape of tiers or an L. It comprises a substantially parallelepipedal step or lower portion 150a, similar to the first protruding element 50 in FIG. 3, which directly extends the upper wall of the adapter and bears a step or upper portion 160b that is offset longitudinally towards the rear with respect to the lower portion 150a.

The lower portion 150a has a given shape and dimensions in order to be inserted into the opening 38b in the yoke with little clearance or without clearance. This lower portion 150a defines an upper surface 150aa which is parallel to the upper wall 126c of the adapter and which is oriented on the opposite side from this upper wall, such that it is intended to cooperate with the internal face of the upper wall 36c of the cover 30 by sliding, as can be gathered from FIGS. 6a and 6b, which show the cover in forward and retracted positions, respectively.

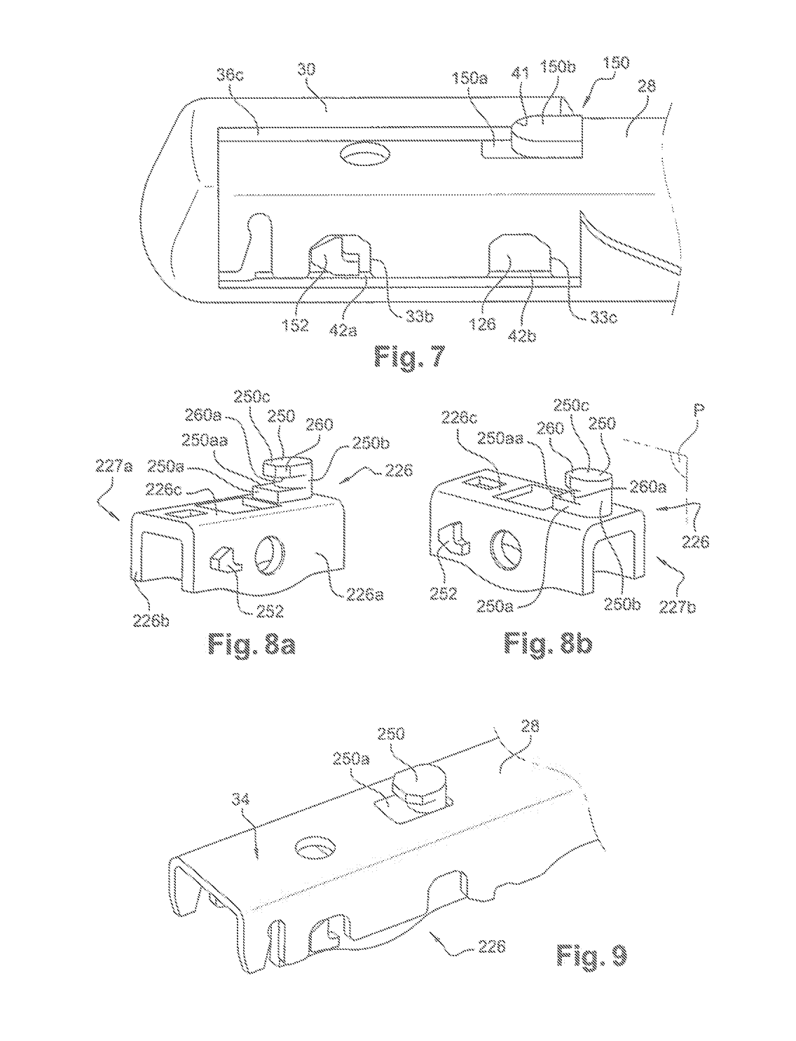

The upper portion 150b has a parallelepipedal overall shape, the front end of which is rounded, it forms a rear longitudinal tab 160, the tower surface of which defines the abovementioned lower surface 160a. The tab is offset longitudinally with respect to the lower portion 150a and it is arranged so as to extend longitudinally beyond the rear longitudinal end edge 127b. This surface 160a is parallel to the upper wall 126c of the adapter and is intended to cooperate with the upper face of the upper wall 34 of the yoke by sliding, as is visible in FIG. 5 notably. It is clear from FIGS. 6b and 7 that the notch 41 has a shape complementary to the front end of the upper portion 150b.

The adapter 126 is formed here in one piece and has to longitudinal median pane P of symmetry parallel to the side walls 126a, 126b and passing substantially through the middle of the upper wall 126c. This plane P passes through the first protruding element 150 substantially in its middle (FIG. 4a).

The cooperation of the first protruding element 150, and in particular its tab 160, with the yoke 28 of the arm makes it possible to hold the adapter 126 with respect to the arm. This first protruding element 150, forming a means for retaining the adapter, is situated in this case in the vicinity of the rear end of the adapter 126. It thus makes it possible to retain the rear end of the adapter with respect to the yoke and can make it possible to dispense with some of the second protruding elements of the adapter. Specifically, the adapter 126 in FIGS. 4a to 7 does not have such second protruding elements at the rear and comprises only two second protruding elements at the front 152, which are situated in the vicinity of the front end of the adapter and which are intended both to be inserted into the intermediate notches 33b in the yoke when the cover is in the forward position on the yoke, and to cooperate with the abovementioned front lips 42a of the cover when the latter is in the retracted position on the yoke (FIG. 7).

The adapter is mounted with respect to the yoke by inserting the upper portion 150b into the orifice in the yoke and then tilting the adapter about the front edge delimiting the orifice. The adapter is then pushed far enough for the tab 260 to be folded against the upper wall 34 of the yoke, by tipping the adapter in the opposite direction. The lower portion 150a of the first protruding element is then fitted in the orifice in the yoke before it is locked in position by sliding the cover 30.

In the case of FIGS. 8 to 11, the first protruding element 250 comprises a lower surface 260a which is oriented towards said upper wall 226c of the adapter 226 and which is configured to cooperate with the cover 30 by bearing and/or sliding in order to retain the adapter with respect to the yoke 28 and the cover.

In the example shown, the first protruding element 250 is in the overall shape of a U. It comprises a substantially parallelepipedal lower portion 250a, similar to the first protruding element 50 in FIG. 3, a substantially cylindrical intermediate portion 250b, and an upper portion 250c defining a tab 260 oriented longitudinally forwards.

The lower portion 250a has a given shape and dimensions in order to be inserted into the opening 35b in the yoke with little play or without play. This portion 250a defines an upper surface 250aa which is parallel to the upper wall 226c of the adapter and is intended to cooperate with the internal face of the upper wall 36c of the cover 30 by sliding, as can be gathered from FIGS. 10a and 10b, which show the cover in forward and retracted positions, respectively.

The intermediate portion 250b is intended to be inserted into the notch 41 in the cover 30 and to follow its shape substantially without clearance. The upper portion 250c has a parallelepipedal overall shape, the rear end of which is rounded and the corners of its front end are bevelled. The tab 260 defines the abovementioned lower surface 280a. This surface 260a is parallel to the upper surface 250aa and opposite the latter, at a given distance to form a region for receiving the cover 30. This upper surface 260a is intended to cooperate with the upper face of the upper wall 36c of the cover 30 by sliding, as is visible in FIG. 11 notably.

The adapter 226 is formed here in one piece and has a longitudinal median plane P of symmetry parallel to the side was 226a, 226b and passing substantially through the middle of the upper wall 228c. This plane P passes through the first protruding element 250 substantially in its middle (FIG. 8b).

The cooperation of the first protruding element 250, and in particular its tab 260, with the sliding cover of the arm makes it possible to hold the adapter 226 with respect to the arm. This first protruding element 250 forming a retaining means is situated in this case in the vicinity of the rear end of the adapter 226. It thus makes it possible to retain the rear end of the adapter with respect to the yoke and can make it possible to dispense with some of the second protruding elements of the adapter. Specifically, the adapter 226 in FIGS. 8 to 11 does not have second protruding elements at the rear and comprises only two second protruding elements at the front 252, which are situated in the vicinity of the front end of the adapter and which are intended both to be inserted into the intermediate notches 33b in the yoke when the cover is in the forward position on the yoke, and to cooperate with the abovementioned lips 42a of the cover when the latter is in the retracted position on the yoke (FIG. 11).

It will be understood that, in this variant of the first aspect of the invention, the mounting of the adapter in the yoke is simplified by the fact that the upper portion 250c forming a tab 260 does not extend beyond the rear longitudinal end edge of the adapter. A simple operation of translational movement makes it possible to pass the first protruding element through the orifice in the yoke in order to offer a receiving region to the sliding cover in its retracted position.

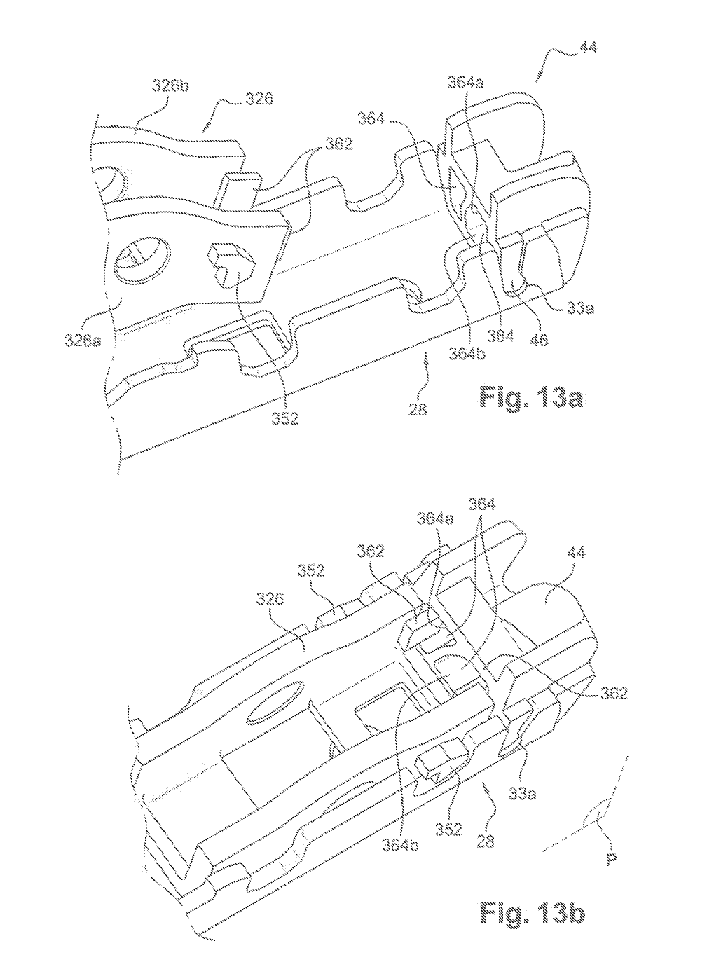

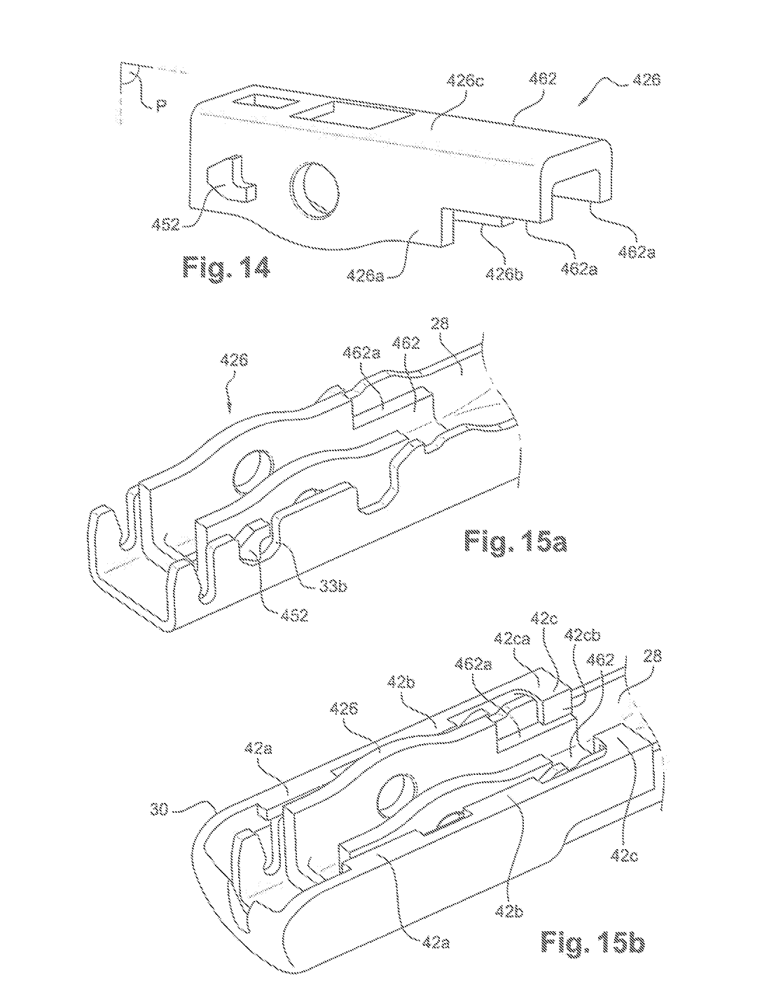

FIGS. 12 to 15b illustrate a second aspect of the invention, FIGS. 12 to 13b showing a first embodiment of this aspect and FIGS. 14 to 15b showing a variant embodiment.

According to this second aspect of the invention, the body of the adapter 326, 426 comprises, at at least one of its longitudinal ends, at least one tab 362, 462 which extends in the longitudinal direction and which is configured to cooperate with the arm 12 or a member borne by the arm such as the cover 30 or the end fitting 44, in order to retain the adapter with respect to the arm or to this member.

In the case of FIGS. 12 to 13b, the adapter 326 comprises front tabs 362 which are intended to be inserted into recesses 364 in the end fitting 44 mounted at the free front end of the yoke of the arm. The end fitting 44 is mounted as explained above, by inserting its ribs 46 into front notches 33a in the yoke 28.

The front tabs 362 extend longitudinally forwards from the side walls 326a, 326b. They are substantially parallel. They each have a parallelepipedal overall shape. The extend over the majority of the height of the side wells 326a, 326b.

The recesses 364 are situated at the rear end of the end fitting 44 and communicate with the internal space of the yoke 28 when the end fitting 44 is mounted at the free end of the yoke. Each of the recesses 364 comprises a lower surface 364a and an upper surface 364b, which can cooperate with the lower and upper ends, respectively, of the front tabs 362 by bearing.

As in the previous example, the adapter 326 can comprise only two second protruding elements 352 on the external faces of its side walls 326a, 326b.

In the case of FIGS. 14 to 16b, the adapter 426 comprises a rear tab 462 which is intended to be inserted into the yoke and to cooperate with the rear lips 42c of the cover 30 by bearing and/or abutment.

The tab 462 extends longitudinally rearwards from the upper wall 426c and the side walls 426a, 426b, it is in the overall shape of a U and is formed by the rear longitudinal extension of the walls 426a, 426b, 426c. It extends across the entire width of the upper wall 326c and over a part of the height of the side walls 426a, 426b.

The free lower longitudinal edges 462a of the tab 462 are intended to cooperate with the free upper ends of the portions 42cb of the rear lips 42c by bearing, as is visible in FIG. 15b.

As in the previous example, the adapter 426 can comprise only two second protruding elements 462 on the external faces of its side walls 426a, 426b. It will be understood that, in the two cases of the second aspect of the invention, the at least one tab 362, 462 and the second protruding element 352, 452 are disposed longitudinally on either side of the articulation axis Y of the adapter such that it is defined by the alignment of the through-orifices provided respectively in each side wall of the adapter, it being understood that the articulation axis of adapter could be defined by the alignment of male means if the associated connector were equipped with female means. This longitudinal disposition on either side of the articulation axis allows stable mounting, regardless of whether it is obtained with a tab in the vicinity of the rear end of the adapter and a second protruding element in the vicinity of the front end, as is illustrated, or in a reverse disposition in which the tab is in the vicinity of the front and of the adapter and the second protruding element is in the vicinity of the rear end.

In the abovementioned two last cases, the adapter 326, 426 is formed in one piece and has a longitudinal median plane P of symmetry.

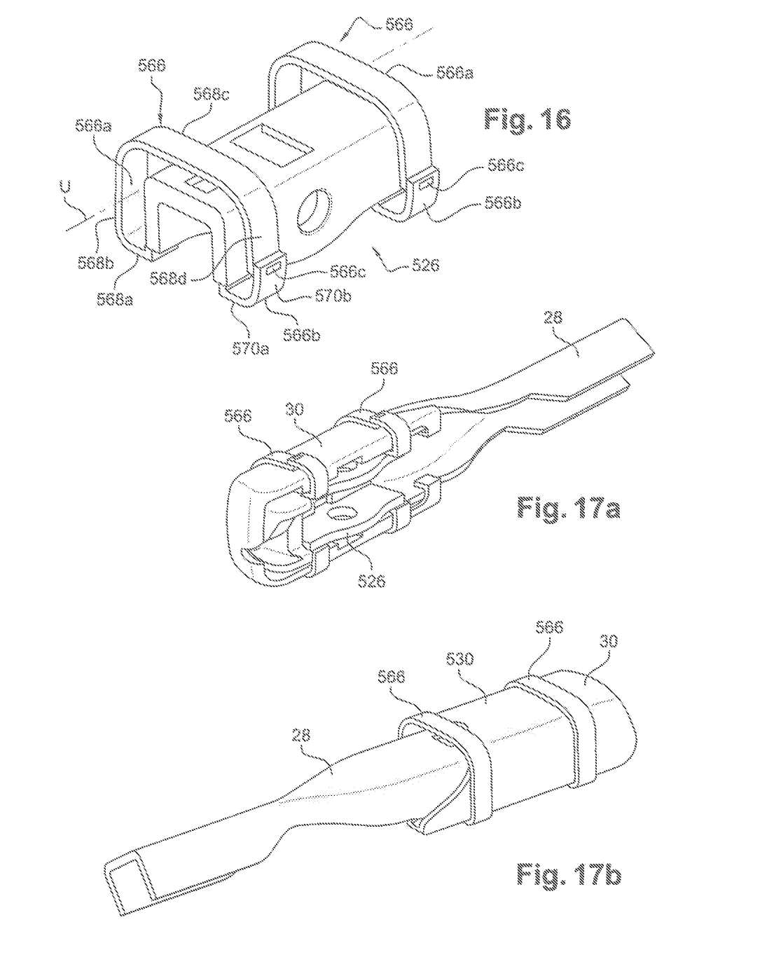

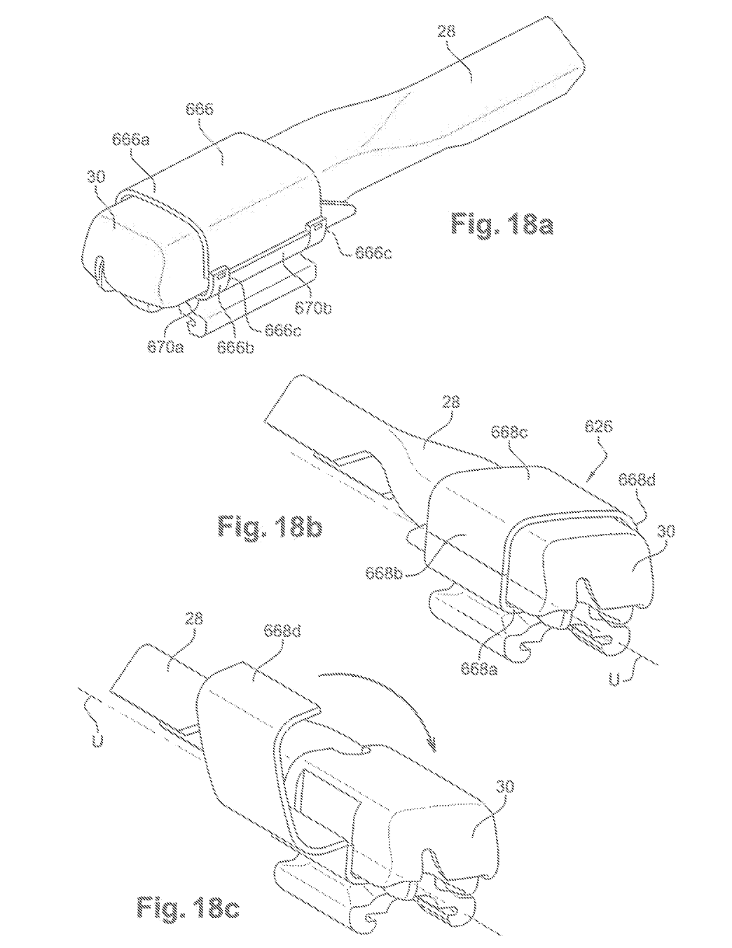

FIGS. 16 to 18c illustrate a third aspect of the invention, FIGS. 16 to 17b showing a first embodiment of this aspect and FIGS. 18a to 18c showing a variant embodiment.

According to this third aspect of the invention, the adapter 526, 626 comprises at least one fastening device 566, 666, which is configured to form a closed loop about the yoke 28 or a member mounted on the yoke, such as the cover 30.

In the case of FIGS. 16 to 17b, the adapter 526 comprises a fastening device formed by two straps 566, a front strap and a rear strap, respectively. The straps are flexible or elastically deformable. They are parallel to and at a distance from one another.

In the example shown, each fastening strap can be deformed by bending about at least one longitudinal axis U.

Each strap 666 comprises a first retaining element 566a and a second retaining element 566b, the first retaining element having an end connected to the body of the adapter and an opposite end having a fastening means 566c configured to cooperate with a complementary fastening means at one end of the second retaining element, the opposite end of which is connected to the body. The fastening means 566c is a hook, a lip or a tab, for example.

The body of the adapter has an elongate overall shape and is connected at each of its longitudinal ends to a fastening strap 566. The first retaining element 566a of each strap comprises a first part 568a which extends from the lower end of the side wall 526a of the body, laterally towards the outside of this body. This first part 568a is substantiality perpendicular to the side well 526a and is thus substantially parallel to the upper we 526c. This first part 568a is connected at its end away from the body to the lower end of a second part 568b which extends next to the side wall 526a, parallel to and at a distance from this side wall. This second part 568b is connected by its upper end to one end of a third part 568c which extends above the upper wall 526c, parallel to and at a distance from the latter, and is connected at its end away from the second part 568b to the upper end of a fourth pan, which extends next to the other side wall 526b parallel to and at a distance from this side wall, The lower end of this fourth part bears the abovementioned fastening means 566c.

The second retaining element 566b of each strap comprises a first part 570a which extends from the lower end of the side wall 526b of the body, laterally towards the outside of this body. This first part 570a is substantially perpendicular to the side wall 526b and is thus substantially parallel to the upper wall 526c. This first pen 570a is connected at its end away from the body to the lower end of a second part 570b which extends next to the side wall 526b, parallel to and at a distance from this side wall. This second part 570b comprises at its upper end the complementary fastening means 566c.

In the fastening position of each strap 566 shown in FIG. 16, that is to say in the closed position of the loop, the fastening means 566c of the retaining dements cooperate with one another, for example by interlocking, As can be seen in FIGS. 17a and 17b, the straps 566 are intended to surround the cover 30 mounted on the yoke 28.

The adapter 526 can be secured to the arm and in particular to the yoke of the arm by means of the fastening straps 566. For this purpose, the adapter is inserted into the yoke of the arm as indicated in the preceding text, and the cover is positioned in its retracted position on the yoke. The fastening straps are then dosed by disposing them around the cover and bringing their fastening means 566c into cooperation.

In the case of FIGS. 18a to 18c, the adapter 626 comprises a fastening device in the form of a folding cover 666. The fastening device is specifically able to be articulated between an open position, shown in FIG. 18c, allowing the adapter to be mounted/removed with respect to the yoke, and a closed position, shown in FIGS. 16a, 18b, in which the adapter is locked with respect to the yoke.

In the example shown, the fastening device comprises a folding cover configured to cover the yoke at least in part. The folding cover is in this case articulated about a longitudinal axis U. The folding cover is in the over shape of a U, the upper wall of the folding cover (formed by the abovementioned third part) being configured to cover the cover 30, and its side walls being configured to extend along two opposite sides of the cover 30.

The folding cover 666 comprises a first strap element 666a and a second retaining element 666b. The first retaining element 666a comprises the folding cover on a portion secured to the body of the adapter. The folding cover comprises, at an end away from this portion, a fastening means 666c configured to cooperate with a complementary fastening means at one end of the second retaining element, the opposite end of which is connected to the body. The fastening means 666c is a hook, or a tab, for example.

The first retaining element 666a comprises a first part 668a which extends from the lower end of the side wall (the one equivalent to the wall 526a in FIG. 16) of the body, laterally towards the outside of this body. This first part 668a is substantially perpendicular to the side wall (526a) and is thus substantially parallel to the upper wall (the one equivalent to the well 526c in FIG. 16). This first part 668a is connected at its end away from the body to the lower end of a second part 668b which extends next to the side wall (526a), parallel to and at a distance from this side wall. This second part 666b comprises the articulation means of the folding cover and is connected by its upper end to one end of a third part 668c which extends above the upper wall (526c), parallel to and at a distance from the latter, and is connected at its end away from the second part 668b to the upper end of a fourth part, which extends next to the other side wall the one equivalent to the wall 526b in FIG. 16), parallel to and at a distance from this side wall. The lower end of this fourth part bears the abovementioned fastening means 666c.

The second retaining element 666b comprises a first part 670e which extends from the lower end of the side all (526b) of the body, laterally towards the outside of this body. This first part 670a is substantially perpendicular to the side wall (526b) and is thus substantially parallel to the upper wall (526c). This first part 670a is connected at its end away from the body to the lower end of a second part 670b which extends next to the side wall (526b), parallel to and at a distance from this side wall. This second part 670b comprises at its upper end the complementary fastening means 666c.

The articulation means of the retaining cover can be formed material web.

In the fastening position of the folding cover 666 shown in FIGS. 18a and 18b, that is to say in the closed position of the loop, the fastening means 666c of the strap elements cooperate with one another, for example by interlocking.

The adapter 626 can be secured to the arm and in particular to the yoke of the arm by means of the folding cover 666. For this purpose, the adapter is slid into the yoke of the arm as indicated in the preceding text, and the sliding cover 30 is positioned in its retracted position on the yoke. The fastening device is then closed by folding the folding cover over the sliding cover and by bringing the fastening means 666c of the folding cover 666 no cooperation.

In the two last variants, the adapter 526, 626 is formed in one piece. body does not have second protruding elements of the type of those 52, 54 shown in FIG. 3 on its external side faces of its side walls.

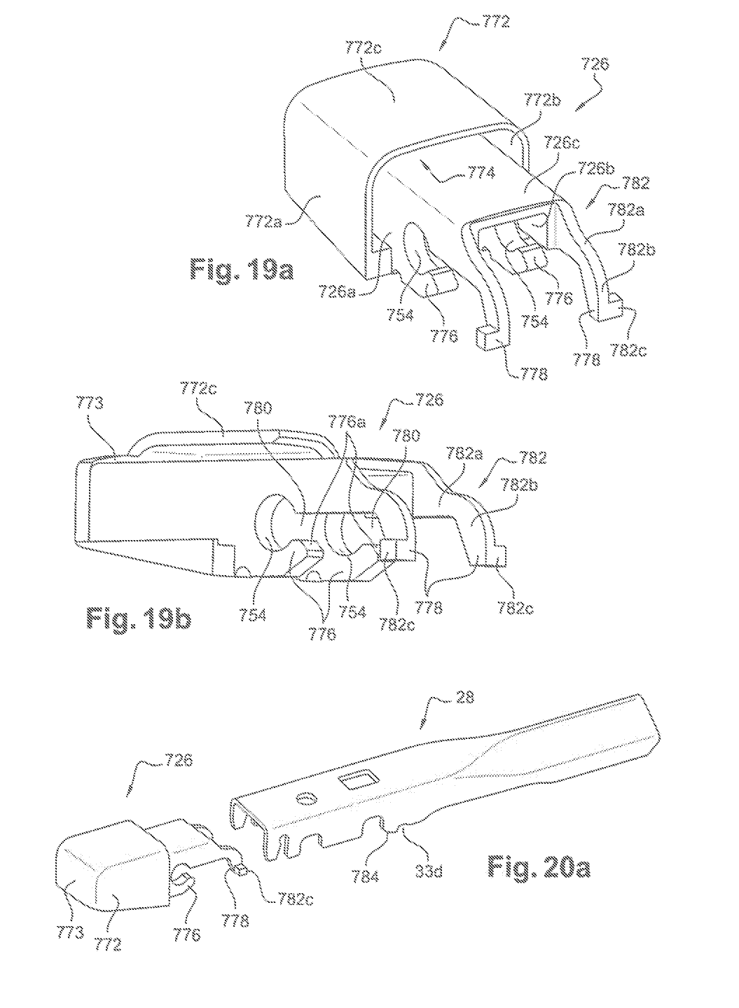

FIGS. 19a to 21 illustrate a fourth aspect of the invention, in which the adapter 726 comprises a body of elongate shape configured to be secured to the yoke 28 of substantially U-shaped cross section of a wiper arm.

The body has a cross section substantially in the shape of a U and has two longitudinal side walls 726a, 726b connected together by an upper longitudinal wall 26c.

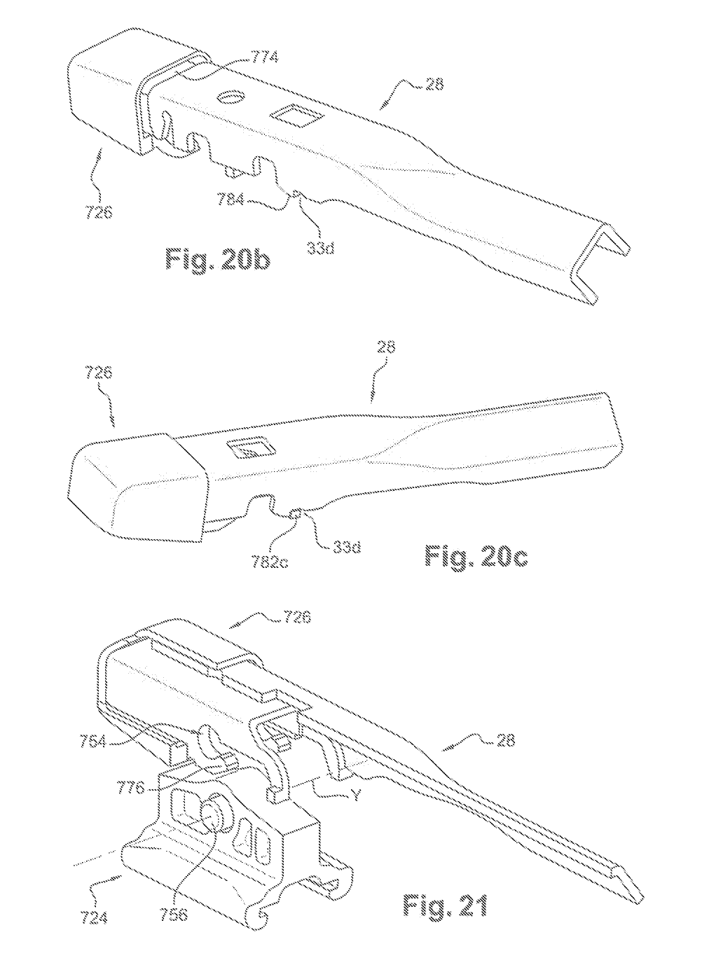

The adapter 726 comprises at one longitudinal end of the body a cowling 772 secured to the body. This cowling 772 is intended to replace :he sliding cover 30 described in the preceding text. The cowling 772 ha a cross section substantially in the shape of a U and has two side walls 772a, 772b that are connected together by an upper wall 772c and extend respectively parallel to and at a distance from the side walls 726a, 726b and from the upper wall 726c of the body so as to define a housing 774 for receiving an end part of the yoke 28 between these walls (FIGS. 20b-21). This housing is in the overall shape of a U. The front longitudinal end wall 773 of the cowling forms a bottom wall of the housing, such that it forms a stop wall for the insertion of the end of the yoke into the housing 774.

The side walls 726a, 726b of the body have articulation means 754 that are configured to receive first complementary means 756 of the connector 724 and are joined to first elastically deformable elastic fastening means 776 that are configured to cooperate with these complementary means 756 while they are being received by the articulation means 754.

The side walls 726e, 726b of the body also have second elastically deformable elastic snap-fastening means 778 that are configured to cooperate with second complementary means 33d of said yoke 28.

In the example shown, the side walls 726a, 726b respectively comprise two orifices 754 which are aligned and form the abovementioned articulation means.

The side walls 726a, 726b respectively comprise two longitudinal slots 780 which extend from the orifices 754 on the opposite side from said cowling 772.

Each of the side walls 726a, 726b comprises a lower longitudinal tab, an upper part of which defines a peripheral pan of the corresponding orifice 754. This lower tab is elastically deformable at least in part so as to form said first elastic snap-fastening means 776.

The lower tab has a free longitudinal end having a sliding ramp 776a configured to cooperate with the complementary means 756 of the connector, which are in this case a journal (FIG. 21).

Each of said side walls 728a, 728b comprises an upper tab 782, a lower part of which defines a peripheral part of the corresponding orifice 754. The upper tab 782 is elastically deformable at least in part and forms said second elastic snap-fastening means 778.

The upper tab 782 is in the overall shape of an L and comprises two substantially rectilinear portions, a first portion 782a of which extends from the corresponding orifice 754 on the opposite side from the cowling 772 and is connected, on the opposite side from the cowling, to a second portion 782b which extends downwards.

The second portions 782b of the upper tabs 782 respectively comprise two transverse fingers 782c that extend in opposite directions and are configured to be inserted by elastic snap-fastening into the complementary means of the yoke 28, which are the rear notches 33d in this case.

The fingers 782c extend in one and the same longitudinal plane that passes substantially through the abovementioned lower tabs.

The adapter 726 is formed in one piece.

The adapter 726 in FIGS. 19a to 21 can be mounted in the following manner. As shown in FIGS. 20a and 20b, the yoke 28 is mounted on the body of the adapter 726 by longitudinal translational movement from the rear to the front, until its front free end is inserted into the abovementioned housing 774 of the adapter and the fingers 782c are inserted into the rear notches 33d of the yoke 28 (FIG. 20c) by snap fastening and elastic return towards the outside. During this translational movement, the fingers 782c run along the free end edge of the side walls. When the fingers arrive close to the rear notch, they first of all come into contact. with a boss 784 formed upstream of the rear notch, and the fingers then run along the boss by elastic deformation of the upper tabs 782. When the boss 784 has been passed, the tabs tend to return to their original position and the fingers are accommodated in the notch, in order to be retained therein with longitudinal clearance by the shoulder formed by the boss, in this position, the adapter 726 is secured to the yoke 28. The adapter is then mounted on the connector 724 by inserting the journals 756 of the connector 724 into the orifices in the adapter. The journals 756 are inserted into the slots 780 and bear against the ramps 776e. A longitudinal translational movement of the connector towards the adapter causes the journals 756 to slide over the ramps 776a and the lower tabs of the adapter to deform, this translational movement being continued until the journals are inserted into the orifices 754 in the adapter by elastic snap-fastening, The journals cooperate with these orifices to allow rotational movements of the adapter with respect to the connector and vice versa, about the abovementioned axis Y.

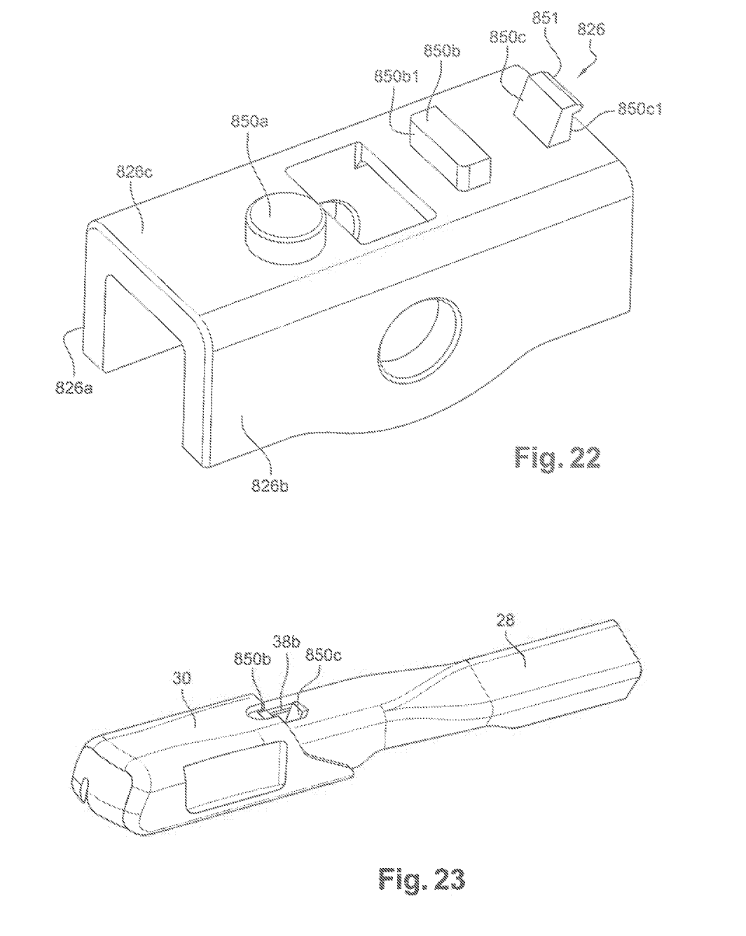

FIGS. 22 and 23 illustrate a fifth aspect, of the invention, in which the adapter 826 comprises a body of elongate shape configured to be secured to the yoke 28 of substantially U-shaped cross section of a wiper arm.

The body has a cross section substantially in the shape of a U and has two longitudinal side was 826a, 826b connected together by an upper longitudinal wall 826c.

The upper wall 826c has at least one protruding element 850a, 850b, 850c configured to be accommodated in at least one through-orifice 38a, 38b in the yoke 28, in the example shown, the adapter 626 comprises three protruding elements 850a, 850b, 850c, which are each intended to be inserted into an orifice 38a, 38b in the yoke only one of these orifices 38b being visible in FIG. 23 and being intended to receive two of the protruding elements 850b, 850c. That orifice 38a in the yoke that is intended to receive the other protruding element 850a is concealed by the cover 30 mounted on the yoke 28, in the retracted position in FIG. 23.

The protruding elements 850a, 850b, 850c are disposed one after another in the longitudinal direction. The front element 850a is in the overall shape of a cylinder. The intermediate element 850b has a parallelepipedal overall shape and the rear element 850c is hook-shaped or L-shaped. This rear element 850c comprises a first, lower part substantially perpendicular to the upper wall 826c and extending upwards from the latter, its upper end is connected to an upper part such as a lip 851, which is substantially parallel to the upper with 826c end which extends rearwards.

The intermediate element 850b comprises a front surface 850b1 that is oriented longitudinally towards the front and is intended to cooperate with a complementary surface, oriented towards the rear of the orifice 38b in the upper wall 34 of the yoke 28, by bearing. The rear element 850c comprises a rear surface 850c1 that is chanted longitudinally towards the rear and is intended to cooperate with a complementary surface, oriented towards the front of the orifice 38b, by bearing, as is visible in FIG. 23. This rear surface 850c1 is in this case borne by the lower part of the element 850c.

FIG. 23 also shows that the upper lip 851 is configured to cooperate with the upper face 34 of the yoke 28 by bearing in order to retain the adapter with respect to the yoke.

The surfaces 850b1, 850c1 are configured to be kept clamped against the complementary surfaces of the orifice 38b in order to retain the adapter 826 with respect to the yoke 28. Notably, provision is made for the rear protruding element 850c to be a flexible tab, which can be articulated about an axis defined by the junction between the tab and the upper wall 826c of the adapter. The protruding elements are thus defined by a centring means associated with an orifice in the yoke, in this case the front element 850a associated with the orifice 38a, and by a fastening means associated with the other orifice and formed by the two remaining protruding elements. At least one of these two remaining elements is a flexible tab.

In a variant that is not illustrated, provision could be made for the two protruding elements forming the fastening means to consist of two flexible protruding elements, which are articulated respectively about an axis formed by the junction line between the upper wall and said corresponding protruding element, and are disposed opposite one another such that the contact surfaces borne respectively by the protruding elements are oriented away from one another.

The body of the adapter 828 in this case does not have a protuberance protruding from its side walls 826a, 826b. The adapter 826 is in this case formed in one piece.

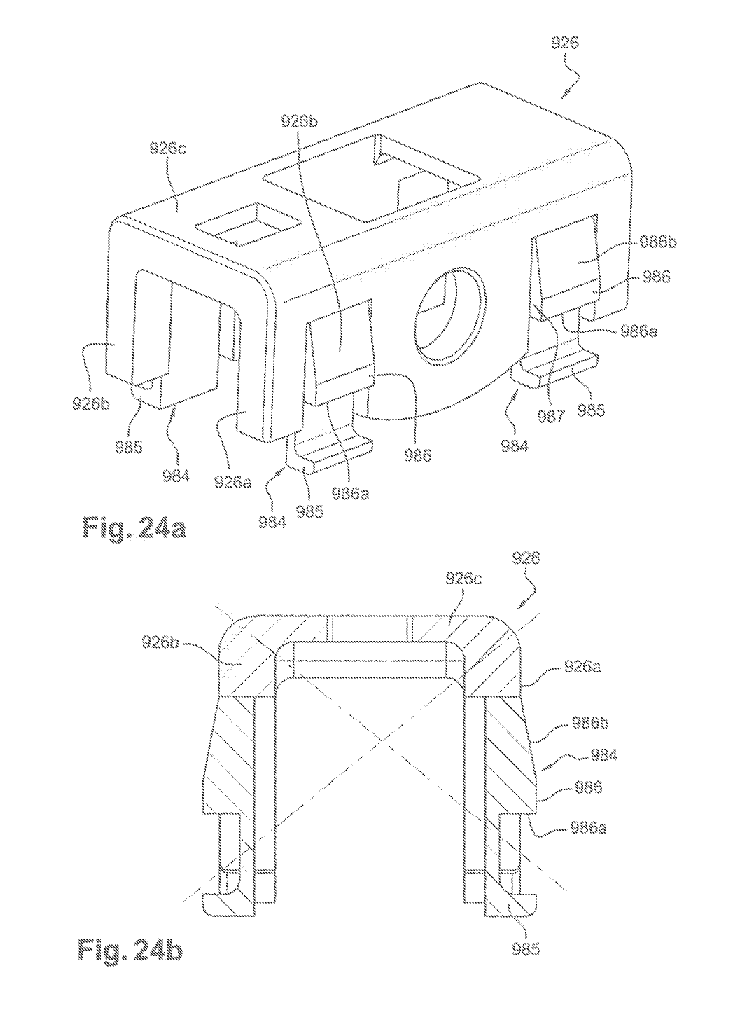

FIGS. 24a and 26 illustrate a sixth aspect of the invention, in which the adapter 928 comprises a body of elongate shape configured to be secured to the yoke 28 of substantially U-shaped cross section of a wiper arm.

The body has a cross section substantially in the shape of a U and has two longitudinal side walls 926a, 926b connected together by an upper longitudinal all 926c.

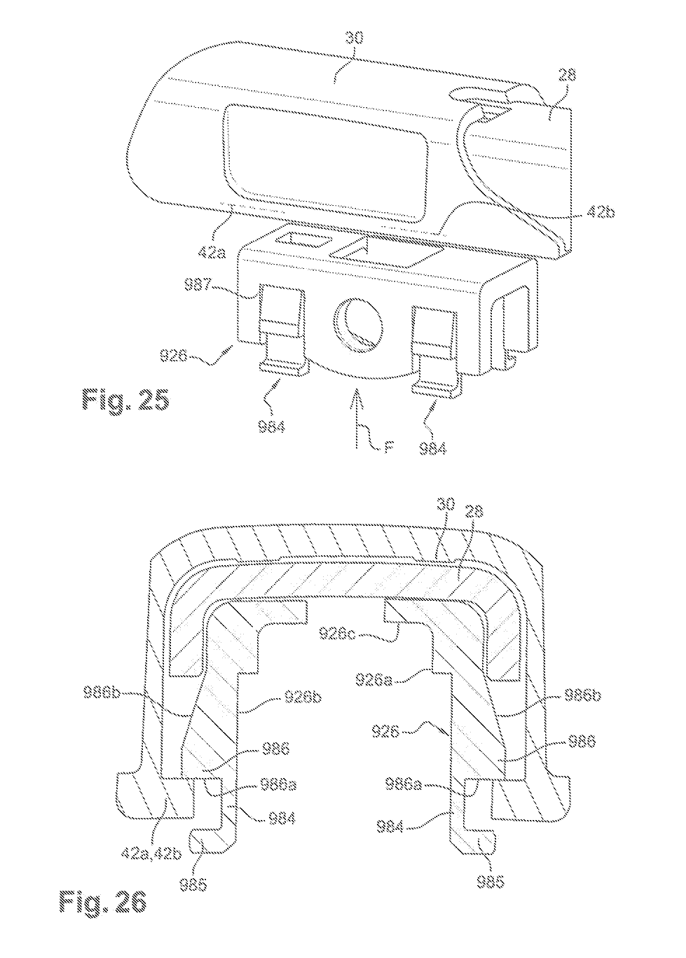

The adapter is configured to be inserted into the yoke by translational movement in a direction substantially perpendicular to the upper wall 926c, from the bottom upwards (arrow F in FIG. 25).

The side walls 926a, 925b comprise tabs 964 that are elastically deformable in the transverse direction and are configured to cooperate by elastic snap-fastening with complementary means 42a, 42b of the yoke 28 and/or of a member mounted on the yoke, such as the cover 30.

The tabs 984 have retaining teeth 985, 986 configured to cooperate with the yoke 28 and/or cover 30.

In the example shown, each side wall 9262, 926b has two elastically deformable tabs 984 that each have two, respectively lower and upper, retaining teeth 985, 986.

Each of the teeth 984 has an overall orientation perpendicular to the upper wall 926c. Each tab 984 is delimited by two parallel through-slots 987 that are formed in the corresponding side wall 926a, 926b and open onto the free lower edge of this side wall. The tabs of one and the same side we are spaced apart from one another. They extend substantially over 60 to 100% of the height of the side walls, or preferably over 70 to 90% of this height.

Each tab 984 comprises a lower tooth 985. This lower tooth 986 forms a lip which extends transversely towards the outside of the body, it is substantially perpendicular to the overall orientation of the tab 984 and thus substantially parallel to the upper wall 926c.

Each tab 984 comprises an upper tooth 986 which forms a protuberance which extends transversely towards the outside of the body. This tooth defines, at its lower end, a retaining surface 986a substantially parallel to the lower tooth 985, and, at its upper end, an external ramp 986b intended to cooperate with the abovementioned complementary means 42a, 42b of the yoke 28 or cover 30 by sliding.

The teeth 985, 986 of each tab 984 are spaced apart from one another and define between one another a space for receiving the means 42a, 42b. This space is more exactly delimited by the surface 988a of the upper tooth and the lip or the lower tooth 985.

The adapter 926 is formed in one piece.

in the example shown, the tabs 984 are configured to cooperate by elastic snap-fastening with the cover 30, and in particular with the guide rails or lips 42e, 42b for guiding the siding of the cover 30.

When the cover 30 is in the retracted position on the yoke 28, the adapter 926 can be mounted in the yoke by being positioned under the yoke, as shown in FIG. 25. The adapter is then moved in a direction substantially perpendicular to the upper wall, in the direction of the arrow until the lips 42a 42b of the cover 30 bear against the ramps 986b of the upper teeth 986 of the tabs 984. The translational movement of the adapter is continued such that the lips 42a, 42b slide over the ramps, thereby bringing about the deformation of the tabs 984 by transverse bending towards the inside of the body, the ends or lower teeth 985 of the tabs 984 borne by one side wall moving towards the ends or lower teeth 985 of the tabs 984 borne by the other side wall. The translational movement of the adapter is continued until the lips 42a, 42b are inserted between the teeth 965, 986 of the tabs, by elastic return of the tabs into their rest position. In this position, the surfaces 986a of the upper teeth 964 can cooperate with the Ups 42a, 42b by bearing so as to prevent downward movement of the adapter with respect to the yoke, that is to say a movement in the opposite direction to that of the arrow F. The lower teeth 985 of the tabs can cooperate with these lips in order to limit upward movements of the adapter with respect to the yoke, in order to remove the adapter from the yoke, it is conceivable to deform the tabs 964 by bending them inwards, manually or by means of a tool, for example by bearing on the lower teeth 985 of the tabs. Alternatively it is conceivable to move the cover 30 towards its forward position such that its tins 42a, 42b do not impair the removal of the adapter from the yoke.

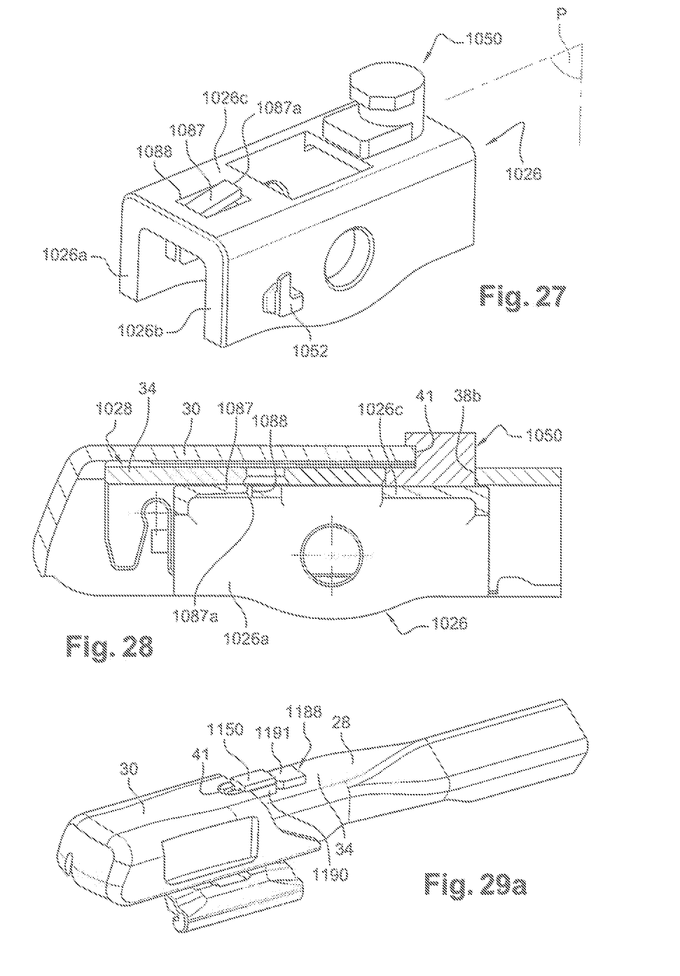

FIGS. 27 and 28 illustrate a seventh aspect of the invention, in which the adapter 1026 comprises a body of elongate shape configured to be secured to the yoke 28 of substantially U-shaped cross section of a wiper arm.

The body has a cross section substantially in the shape of a U and has two side walls 1026a, 1026b connected together by an upper wall 1026c. The upper wall 1026c has a first protruding element 1050 configured to extend at least partially into a through orifice 38b of the yoke 28. This first protruding element 1050 is in this case similar to that in the variant in FIGS. 8a a 12, but could of course be different

At least one of the walls of the body of the adapter comprises an elastically deformable tongue 1087 configured to bear against an internal face of the yoke 28 in order to remove any clearance between the adapter and this internal face.

In the example shown, the adapter 1028 comprises a tongue 1087 of this type, which is situated in this case on the upper wall 1026c of its body.

The tongue 1087 is situated in the vicinity of one longitudinal end of the body, in this case the front end, and the first protruding element 1050 is situated at an opposite longitudinal end, i.e., the rear end, of the body.

The tongue 1087 is flexible and it has an end produced in one piece with the associated wall of the adapter body and a free end 1087a configured to be movable between a nonloaded position in which its free end protrudes from the plane of the upper wall, outside the body (FIG. 27), and a folded and loaded position in which it extends substantially in the plane of the upper wall (FIG. 28). It is situated in a recess or orifice 1088 in the body, in the folded position, it is accommodated at least in part in this orifice and, in the protruding position, it extends upwards from the upper wall 1026c. The tongue 1087 is able to cooperate with the internal face of the upper wall 34 of the yoke 28 by bearing.

The body of the adapter has a plane of symmetry P parallel to the side walls 1028a, 1028b and passing substantially through the middle of the upper wall 1026c. This plane of symmetry P passes substantially in its middle through the tongue 1087.

In the example shown, the body of the adapter 1026 comprises, on an external side face of each of its side walls 1028a 1026b, a single second protruding element 1052 configured to be inserted into the notch 33b (not visible) in the yoke 28.

The adapter is formed in one piece. It is retained in the yoke 28 by the first protruding element 1050, as explained in the preceding text in relation to the variant in FIGS. 8a to 12.

The tongue 1087 cooperates with the yoke 28 to limit the vibrations of the adapter in the yoke in the direction in which the tongue protrudes from the associated wall. The fastening of the adapter in the yoke by way notably of the first protruding element cooperating with the orifice in the yoke, and by the locking of the adapter by the guide rails of the sliding cover as mentioned above, can generate vibrations that are due notably to the mounting clearance of the first protruding element in the orifice. It will be understood that the position of the tongue on one or the other of the walls of the adapter makes it possible to limit the vibrations in a particular direction, substantially perpendicular to the associated wall. In a variant that is not illustrated, at least two tongues could be provided, one on the upper wall and another on at least one of the side walls, in order to limit the vibrations of the adapter with respect to the yoke in several directions.

In each of these cases, it is advantageous to have the tongue(s) disposed at a longitudinal end of the adapter away from the longitudinal end on which the first protruding element is arranged, for better absorption of the vibrations generated by the mounting clearance of the first protruding element with the yoke.

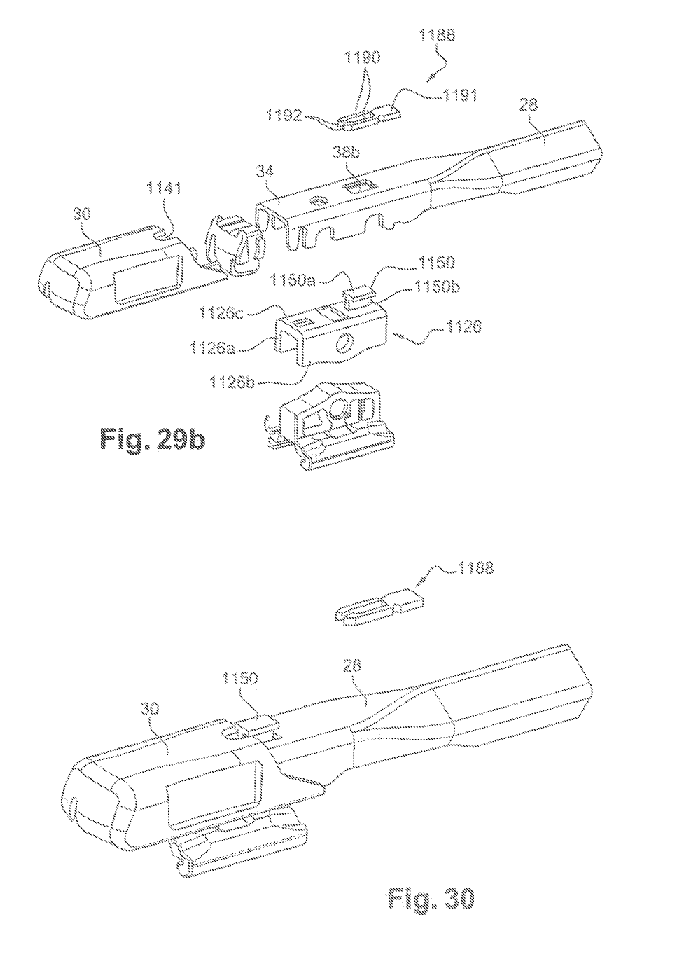

FIGS. 29a to 30 illustrate an eighth aspect of the invention, in which the adapter 1126 comprises a body of elongate shape configured to be secured to the yoke 28 of substantially U-shaped cross section of a wiper arm.

The body has a cross section substantially in the shape of a U and has two side walls 1126a, 1126b connected together by an upper wall 1126c.

The upper wall 1126c has a first protruding dement 1150 configured to extend at least partially into the orifice 38b of the yoke 28.

The adapter 1126 also comprises at least one clip 1188 configured to be attached and fastened to the first protruding element 1150 so as to lock the adapter 1126 with respect to the yoke 28.

In the example shown, the first protruding element 1150 is in the overall shape of a T and comprises a first wall 1150a substantially parallel to the upper wall 1126c and a second wall 1150b for connecting the first wall 1150a to the upper wall 1126c, said second wall being substantially perpendicular to the upper wall 1126c. The second wall 1150b extends substantially in a longitudinal median plane P of symmetry of the body.

The clip 1188 is in the over shape of a U and comprises two substantially parallel longitudinal fingers 1190 connected by one of their longitudinal ends to a common base 1191.

The fingers 1190 are elastically deformable by bending towards and/or away from one another. They comprise retaining hooks 1192 at their ends away from the base 1191. The hooks 1192 are oriented in a transverse direction, one towards the other.

The body of the adapter 1126 in this case does not have protruding elements on its side was 1126a, 1126b. The adapter 1126 is in this case formed in one piece.

As indicated in the preceding text, the cover 30 is configured to be movable in translation between a first position, known as the forward position, in which it is spaced apart from the orifice 38b, and a second position, known as the retracted position, in which it is near to this orifice, or covers it in part as well as a part of the first protruding element. The sliding cover 30 in this case comprises a notch 41 for receiving a front part of the first protruding element 1150 and also a front part of the clip 1188, namely the ends of the fingers 1190 bearing the hooks 1192. Advantageously, in the retracted position of the cover 30, the peripheral edge of the notch 41 of the cover 30 is able to cooperate, by bearing, with the free ends of the fingers 1190 that have surrounded the first protruding element 1150, so as to prevent the fingers from moving away and the clip 1188 from being removed from the element 1150 when the cover is held in this position.

The invention thus proposes a mounting method in which the adapter 1126 is mounted in the yoke 28 of the arm such that the first protruding element 1150 passes through the orifice 38b in the yoke 28. The cup 1188 is mounted around the first protruding element, notably by the clip being slid against the upper wall of the yoke. The fingers are elastically deformed, moving apart from one another, and the hooks 1192 came into contact with the second wall 1150b during the translational movement of the clip. The fingers return to their original shape when the hooks have passed beyond the second wall 1150b, these hooks forming an axial retaining means in abutment against the second wall. The adapter is thus locked with respect to the yoke, the first wall 1150a being in vertical abutment against the fingers such that the first protruding element cannot escape through the orifice. The cover is then moved along the yoke, from its forward position to its retracted position in which the clip 1188 is locked, the peripheral edge of the notch forcing the hooks to move towards one another in order to ensure the position of the clip around the first protruding element.

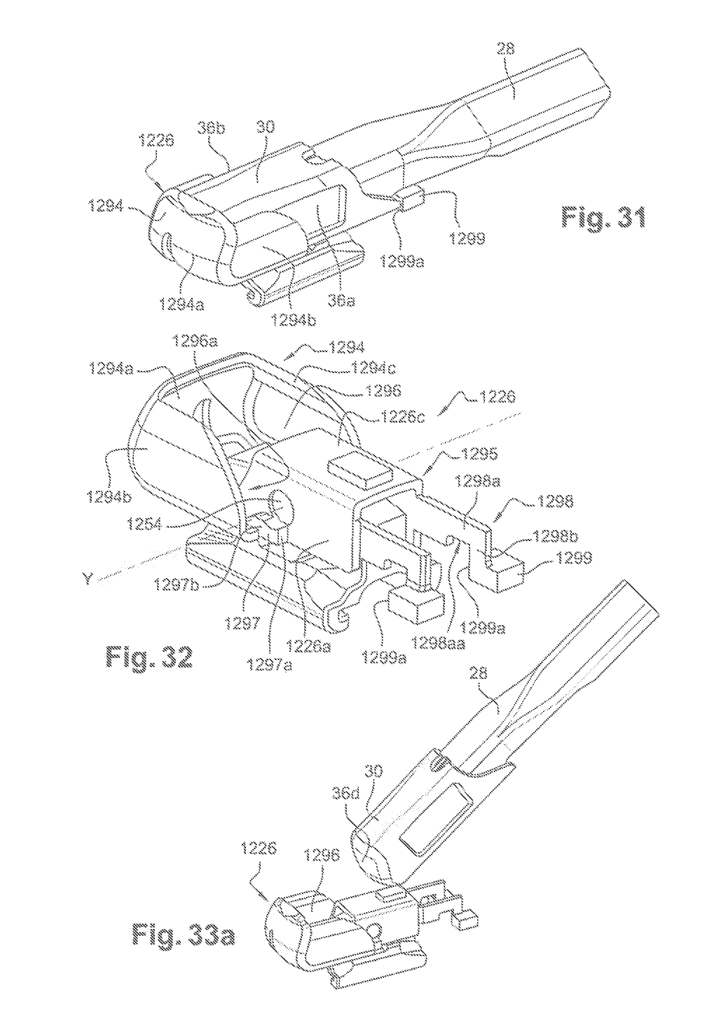

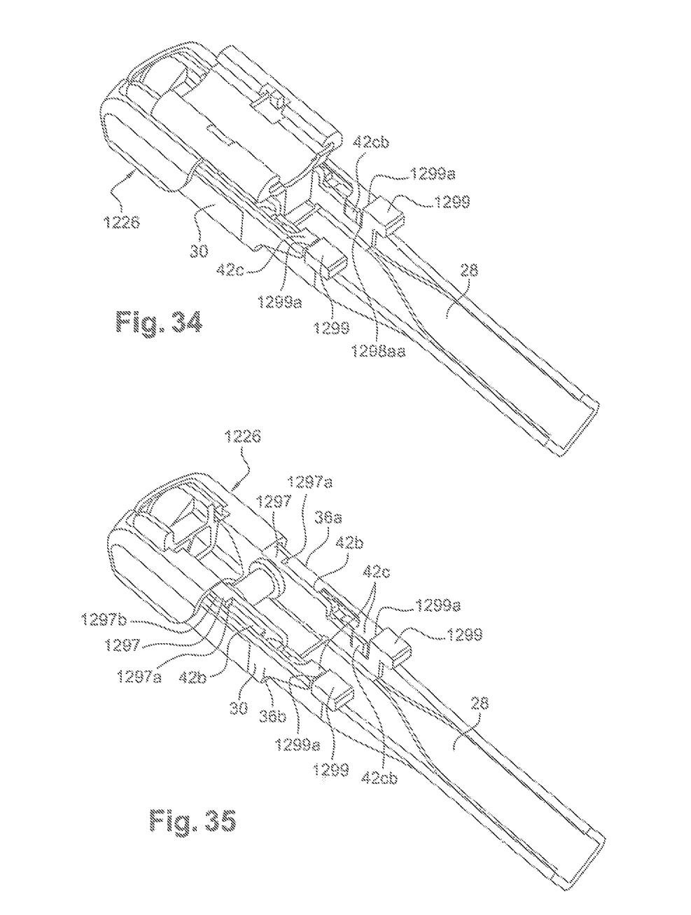

FIGS. 31 to 35 illustrate a ninth aspect of the invention, in which the adapter 1226 has an elongate shape configured to be secured to the, in this case movable, cover 30 disposed at the end of the wiper arm.

The adapter has a front cowling 1294 and a rear body 1295 which has a cross section substantially in the shape of a U and has two side was 1226a, 1225b connected together by an upper wall 1226c.

The cowling 1294 has a front wall 1294a which is configured to extend in front of the rear body 1295 so as to define with the body 1295 a longitudinal space 1296 for receiving a front part of the cover 30.

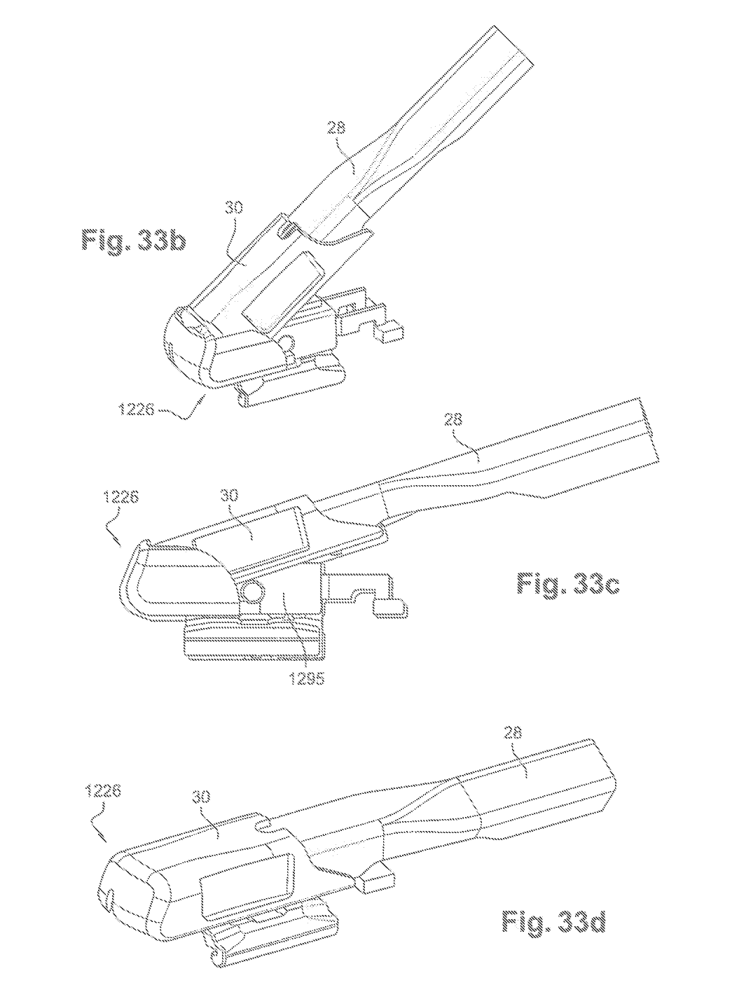

The cowling 1294 is in the overall shape of a U, the opening of which is oriented towards the rear and the median part of which is formed by the front wall 1294a. The side parts of the U are formed by side walls 1294b which extend rearwards from the front wall 1294a. The side walls 1294b are intended to extend on each side of the cover and to cover it, at least laterally, in part (FIG. 33d) when the arm, and the cover it bears, and the adapter are assembled.

The cowling comprises an upper opening 1294c for mounting the cover 30 in the space.

The width of the cowling, that is to say the dimension between the side walls, is greater than the width of the rear body, such that a transverse space 1296a is formed on each side of the rear body between the letter and the cowling.

The side walls 1226a of the body 1295 respectively comprise two aligned orifices 1254 which define the abovementioned articulation axis Y. The side walls also each comprise a lug 1297 protruding from the corresponding side wall. Each lug 1297 is situated under the orifice 1254 in the corresponding side wall 1226a, 1226b, at the junction between this wall and a transverse web Dining the side wall 1226a, 1226b to the lower end of the closest side wall 1294b of the cowling 1294. It will be understood that the transverse web and the lug define the dimension of the transverse space left laterally between the rear body and the cowling. Each lug 1297 has a parallelepipedal overall shape and comprises a face 1297a oriented towards the rear and a face 1297b oriented laterally towards the outside. The face 1297a is a bearing face of a complementary means of the cover, which in this case is the front end of the intermediate lip 42b of the cover. The intermediate Ups 42b of the cover are thus intended to bear against the rear faces 1297a of the lugs 1297 of the adapter, in the mounted position of the cover in the adapter (FIGS. 33d to 35). The face 1297b is a bearing face of a corresponding side wall 36a, 36b of the cover 30. The cover is thus intended to laterally clamp the adapter 1226 by its side walls 36a, 36b bearing against the faces 1297b of the lugs 1297.

The side walls 1229a, 1229b of the body &so have elastically deformable elastic snap-fastening means that are configured to cooperate with complementary means of the cover 30. Each side wall 1229a of the body comprises an elastically deformable longitudinal tab 1298 forming said elastic snap-fastening means. Each tab 1298 is in the overall shape of an L and comprises two substantially rectilinear portions, a first portion 1298a of which extends rearwards in continuation of the rear body, in this case from the side walls, and is connected to a second portion 1298b which extends downwards.

The first portions 1298a each have a notch 1298aa produced by cutting the lower face of the first portion 1298a in the direct vicinity of the second portion 1298b. This notch forms a means for receiving a complementary means borne by the cover, namely the rear lips 42c and more particularly the second, hook-forming portions 42cb of these rear lips. The first portions 1298a of the tabs are connected to the side was by a region with a smaller cross section, facilitating the articulation of the first portions about an axis formed by the unction line between the side was and the tab. The tabs are thus articulated in order to fold transversely.

The second portions 1298b of the tabs respectively comprise two transverse fingers 1299 that extend in opposite directions and are configured to be accessible when the arm and the adapter are secured. The fingers 1299 extend in one and the same longitudinal plane. Each finger 1299 has a parallelepipedal overall shape and comprises a front face 1299a against which the rear lip 42c of the cover can bear The fingers thus help to keep in longitudinal position the cover thus intended to be damped between the rear faces 1297a of the lugs 1297 and the front faces 1299a of the fingers 1299 of the adapter, in addition to the cooperation of the rear lips with the notches of the tabs. These lingers form actuating means that are accessible by the user in order to force the tabs to deform elastically and allow the disengagement of the complementary means of the cover, and thus to allow the disassembly of the adapter with respect to the arm (FIGS. 33d to 35).

The adapter 1226 is formed in one piece.

FIGS. 332 to 33d show steps in the mounting of the cover, and also of the arm bearing the cover, in the adapter. The arm and the cover are disposed as indicated in FIG. 33a, the cover being positioned above the adapter and being ready to be inserted into the space 1296 by passing through the opening 1294c in the cowling 1294. The cover 30 is then moved in longitudinal translation until it is inserted into the space 1295 and the front end wall of the cover comes into contact with the front wall 1294a of the cowling (FIG. 33b). The cover is then moved with the arm, causing it to pivot about a transverse axis situated substantially at the front wall of the cowling. This pivoting can be facilitated by the sliding of the front wall 36d of the cover 20 on the external face of the front wall 1294a of the cowling 1294. The pivoting is continued with the side walls of the cover, which are inserted into the transverse spaces 1296e, disposed on either side of the rear body 1295, this helping to correctly position the arm and the cover transversely in order that the complementary means of the cover cooperate with the elastic snap-fastening means borne by the adapter. The pivoting forces the tabs 1298 into transverse elastic deformation, moving apart from one another in order to allow the hooks 42cb of the rear lips 42c of the cover 30 to pass through. When the hooks are positioned next to the notches 1298aa, the tabs return to their original position in the axis of the side walls of the adapter and the hooks are opposite, optionally bearing against the front faces 1299a of the fingers 1299. in this way, the cover is inserted between the abovementioned faces 1297a, 1299a and is kept loaded in the longitudinal direction, notably between these faces (FIGS. 33c and 33d).

1. An adapter for a motor vehicle windscreen wiper, comprising:
a body of elongate shape configured to be mounted in a yoke substantially U-shaped cross section of a wiper arm, said body having a substantially U-shaped cross section and having two longitudinal side walls connected together by an upper longitudinal wall,
wherein said upper wall has a fastening means configured to be housed in at least one through-orifice of said yoke, said fastening means having two separate elements that protrude from the upper wall and respectively bear a contact surface for contact with an edge of one and the same orifice in the yoke, at least one of said two separate elements being flexible.

2. The adapter according to claim 1, wherein the two protruding elements of said fastening means have a first flexible protruding element, articulated about an axis formed by the junction line between the upper wall and said first protruding element, and a second protruding element in the form of a fixed protuberance.

3. The adapter according to claim 2, wherein said second protruding element is in the overall shape of a parallelepiped.

4. The adapter according to claim 1, wherein the two protruding elements of said fastening means have two flexible protruding elements, respectively articulated about an axis formed by the junction line between the upper wall and said corresponding protruding element.

5. The adapter according to claim 4, wherein the contact surfaces borne respectively by the protruding elements are oriented away from one another.

6. The adapter according to claim 2, wherein the flexible protruding element(s) are in the overall shape of an L and comprise a substantially rectilinear portion that extends upwards from said upper wall and is connected at its upper end to a lip oriented towards a longitudinal end of the body.

7. The adapter according to claim 6, wherein said lip is configured to cooperate with said yoke by bearing so as to retain the adapter with respect to the yoke.

8. The adapter according to claim 1, wherein the upper wall bears a third protruding element.

9. The adapter according to claim 8, wherein said third protruding element is in the overall shape of a cylinder.

10. The adapter according to claim 8, wherein said third protruding element is configured to be inserted into another orifice in said yoke.

11. The adapter according to claim 8, wherein the three protruding elements of the upper wall are aligned.

12. The adapter according to claim 1, wherein said body is formed in one piece.

13. An assembly having a wiper arm and an adapter according to claim 1.

14. The assembly according to claim 13, wherein said arm has an elongate overall shape and has a yoke with a substantially U-shaped cross section and having two longitudinal side walls connected together by an upper longitudinal wall, said arm also having a cover mounted so as to slide in longitudinal translation on the yoke.

15. The assembly having a wiper blade and an adapter according to claim 1, said adapter being mounted on said blade by way of a connector.
